(19) United States
(12) Patent Application Publication
(10) Pub. No.: US 2007/0197418 A1
(43) Pub. Date: Aug. 23, 2007

(54) Microemulsions

(75) Inventor: Wilfried Rahse, Dusseldorf (DE)

Correspondence Address: CONNOLLY BOVE LODGE & HUTZ, LLP, P O BOX 2207, WILMINGTON, DE, 19899, US

(73) Assignee: Henkel KGaA, Dusseldorf (DE)

(21) Appl. No.: 10/589,455

(22) PCT Filed: Feb. 3, 2005
(86) PCT No.: PCT/EP05/01061

§ 371 Date: Oct. 6, 2006

(30) Foreign Application Priority Data
Feb. 14, 2004 (DE) 10 2004 007 3120

(51) Int. Cl. C11D 17/00

(52) U.S. Cl. 510/407

(57) ABSTRACT

Methods comprising contacting a fabric in an automatic washing machine with a microemulsion comprising an oil and an emulsifier system, wherein the emulsifier system comprises a hydrophilic emulsifier and a lipophilic emulsifier; and microemulsions comprising: an oil, an antioxidant, and an emulsifier system; wherein the emulsifier system comprises a hydrophilic emulsifier and a lipophilic emulsifier; and wherein the microemulsion has a droplet size d₅₀ less than 500 nm, which are suitable for use as fabric treatment agents.

The invention relates to the use of microemulsions that comprise oil(s) and a specific emulsifier system for the treatment of fabrics in an automatic washing machine. The invention also relates to a fabric treatment agent whose droplet size d₅₀ is less than 500 nm and which comprises specific components.

Conventional fabric treatment agents are essentially designed for the cleaning and care of fabrics. Besides the cleaning of fabrics, they mainly are improving the hand of the fabrics, softening and uncreasing them, preventing an electrostatic charge on fabrics, for increasing the gloss and the color brilliance of fabrics, for providing the fabrics with a long lasting fragrance, etc. In addition, conventional fabric treatment agents can also facilitate the ease of ironing, contribute to a lower fiber abrasion and improved color retention in spite of frequent washing. As one sees, the focus of conventional fabric treatment agents is almost exclusively on the fabric. However, fabric treatment agents can also satisfy additional consumer requirements. Thus, the European patent EP 0 789 070 B1 discloses the use of a fabric softening composition that comprises a skin benefit agent as an ingredient to render textile fabrics treated with the composition capable of delivering the skin benefit agent to the skin with which the fabrics come into contact, the fabric softening composition comprising 4 to 32 weight percent of a water-insoluble, fabric softening quaternary ammonium compound having two C₁₂₋₂₈ alkyl or alkenyl groups bonded to the nitrogen atom through one or more ester bonds. The same publication discloses the use of a fabric softening composition that comprises a skin benefit agent as an ingredient to render textile fabrics treated with the composition capable of delivering the skin benefit agent so as to provide sensorial and/or cosmetic benefits to the skin with which the fabrics come into contact, wherein the skin benefit agent is a silicone. In this patent, two suitable agents are disclosed that each comprises 4 wt. % of a diesterquat and 1 wt. % of a silicone that benefits the skin. Therefore, the EP 0 789 070 B1 discloses a concept by which not only a benefit to the treated fabric is achieved (fabric softening) but by which moreover an additional benefit is rendered to the skin with which the fabric comes into contact by increasing the wear comfort of the fabric, in that the skin is allocated a cosmetic or sensory benefit.

In this respect it should also be considered that clothing fabrics as such or these residual deposits that remain in the fabric structures after a cleaning process, can also have a deleterious effect on the skin.

In order to reduce this problem, rinse agents, for example, are used to eliminate detergent residues so as to obtain fabrics that are more skin compatible. Thus, DE 199 23 303 C2 describes rinse agents that comprise defined minimum amounts of citric acid, lactic acid, cyclodextrin and ascorbic acid and which are suitable for manufacturing more skin-compatible fabrics.

Against this background, the object of the present invention was to provide the consumer with an alternative possibility of treating fabrics.

This object is achieved by the use of a microemulsion for treating fabrics in an automatic washing machine, wherein the microemulsion comprises oil(s) and an emulsifier system of at least one lipophilic and at least one hydrophilic emulsifier. In this respect, the inventive use is preferably foreseen in the rinse cycle of an automatic washing machine and the microemulsion is particularly characterized in that it has a droplet size d₅₀ of less than 500 nm. Of course, the use is also possible in all other washing cycles of an automatic washing machine, for example, in the prewash cycle or main wash cycle, the microemulsion then being preferably a liquid detergent. Preferably, the oils have skin-protecting and/or skin-caring and/or skin-healing properties. The droplet size d₅₀ is understood to mean the characteristic value for which the sum of the distribution of the droplet diameters assumes the value 0.5=50%. For example, the statement “d₅₀=a μm” means that 50 (weight)% of the droplets in the product under consideration have a diameter greater than a Am and 50 (weight)% have a diameter less than a μm.

Microemulsions and their manufacture have already been described in the patent literature. A review of the manufacture and application of microemulsions is given by H. Eicke in the SÖFW-Journal, 118, 311 (1992) and by Th.Förster et al. in the SÖFW-Journal, 122, 746 (1996).

For example, DE 37 16 526 C2 discloses a stable oil-in-water microemulsion that consists of 1 to 10 wt. % of a water-soluble anionic surfactant or 2 to 20 wt. % of a mixture of water-soluble anionic and water-soluble non-ionic surfactants, together with 2 to 10 wt. % of a co-surfactant selected from the group of polypropylene glycol ethers, monoalkyl ethers and specific esters of ethylene glycol or propylene glycol, aliphatic mono and dicarboxylic acids having 3 to 6 carbon atoms in the molecule, C₉- to C₁₅- alkyl ether polyetheneoxycarboxylic acids, and mono, di and triethyl phosphate, in addition to 0.4 to 10 wt. % of water-insoluble fragrant perfume comprising 0 to 80 wt. % terpenes, and water, wherein the inorganic or organic salt of a multivalent metal is optionally present, but without builder or solubilizing agent. The same publication also discloses concentrated oil-in-water microemulsions that consist of 10 to 35 wt. % of a water-soluble anionic surfactant or 18 to 65 wt. % of a mixture of water-soluble anionic and water-soluble non-ionic surfactants, together with 2 to 30 wt. % of a co-surfactant selected from the group of polypropylene glycol ethers, monoalkyl ethers and specific esters of ethylene glycol or propylene glycol, aliphatic mono and dicarboxylic acids having 3 to 6 carbon atoms in the molecule, C₉- to C₁₅-alkyl ether polyetheneoxycarboxylic acids, and mono, di and triethyl phosphate, in addition to 10 to 50 wt. % of water-insoluble fragrant perfume comprising 0 to 80 wt. % terpenes, and water, wherein the inorganic or organic salt of a multivalent metal is optionally present, but without builder or solubilizing agent. The microemulsions described in DE 37 16 526 C2 act primarily as stable, clear, all-round cleansers for hard surfaces with a particular efficiency for removing oily and fatty dirt.

In contrast, the subject matter of the present invention involves the use of a microemulsion for treating fabrics in an automatic washing machine. This subject matter offers various advantages. A very important advantage is that the alternative possibility for treating fabrics that is offered to the consumer by the subject matter of the invention, is effected without problem in an automatic washing machine, as the use of the microemulsion is particularly characterized in that the microemulsion can be very well rinsed out of the dispensing draw of a normal commercial automatic washing machine into the wash. In addition, the dispersability of the microemulsion is also very good in cold water. A further advantage of the invention is that the inventive use of the microemulsion has a double advantage for the consumer. Firstly, the microemulsion, as a result of the oil(s) and emulsifiers, acts as a typical fabric treatment agent, e.g. by affording a softer hand to the washing treated in the washing machine. Secondly, the microemulsion, as a result of the inventive use, also brings an advantage to human skin, in that the fabrics treated with the microemulsion serve the well-being of the skin in regard to skin health in so far as, for example, the risk of skin irritations is not further increased by contact of the skin with treated fabric, but rather is even reduced, or such that already irritated or aggravated or sensitized skin is not further damaged by contact with the treated fabric but rather calmed. This is afforded by the subject matter of the invention in so far that the oil(s) comprised in the microemulsion preferably, at least partially, carry over onto the fabric fibers in the washing machine, and these oils, on contact of the treated fabric fibers with human skin, at least partially carry over from the fiber to the skin, such that the treated fabric therefore acts as a temporary host for the oils. Care of the skin with oil by means of this temporary host advantageously enriches the skin in the abovementioned manner as the oil has preferably skin-protective and/or skin caring and/or skin healing properties. In this way the skin can be given a cosmetic or sensory benefit or benefits in addition to these.

In this way, for example, a drying out of the skin can be advantageously countered and also the scruffiness of the skin can be advantageously reduced.

Here, the oil does not completely migrate, but advantageously only partially migrates onto the skin. In the context of the invention, the remaining part of the skin-healing and/or skin-protecting substance on the fabric fiber is appreciated as advantageous for two reasons:

Firstly, there sometimes occurs dermatological problems as the result of a direct skin incompatibility with specific types of fibers Because the oils, preferably the oils with skin-protecting and/or skin-caring and/or skin-healing properties partially remain on the fabric, the contact between the fiber and the bare skin is reduced, such that in the broadest sense, the skin-healing substance can be considered as a fiber coating.

Secondly, modem detergents have enabled excellent optical cleaning effects to be obtained even at relatively low wash temperatures. By reducing the wash temperature, it can be assumed that specific detrimental microorganisms of the human natural skin flora, which are destroyed at higher temperatures, will now survive the wash process. Active ingredients of the oils act antiseptically against this problem.

In the scope of the present application, emulsifiers are considered as lipophilic essentially when they are preferably predominantly soluble in or miscible with C₁₂-C₂₀ triglycerides. Lipophilic properties can be produced inter alia if the emulsifiers have, for example, hydrocarbon groups with 6 to 22 carbon atoms or for example comprise aryl groups, the examples being descriptive but not limiting. Lipophilic emulsifiers have essentially a slightly polar, rather than apolar character. Lipophilic, cationic emulsifiers illustrate preferred lipophilic emulsifiers in the context of this invention. In contrast, in the context of the present application, emulsifiers are considered as essentially hydrophilic when they are preferably predominantly soluble in or miscible with water. Hydrophilic emulsifiers have essentially a polar character. Hydrophilic properties can be produced inter alia if the emulsifier comprises, for example, hydroxyl group(s), ester group(s), ether group(s) or glycerin group(s), the examples being descriptive but not limiting.

The terms skin care, skin protection and skin healing are to be differentiated. Skin care essentially produces a cosmetic benefit in regard to sensory needs e.g. softness or gloss of the skin under normal conditions.

On the other hand, the term skin-protection is understood to mean all that is required to maintain the usual performance of the skin in regard to its functions under conditions of specific exposure and which exceed its own protection mechanisms. Consequently, this term also differs significantly from skin care, as skin care essentially produces a cosmetic benefit in regard to sensory needs e.g. softness or gloss of the skin under normal conditions. Skin protection, however, supports the skin with additional agents that for example, under adverse conditions, help the skin to fulfil its diverse functions. Such adverse conditions can be e.g. abrasion, cold, heat, UV radiation, aggressive ambient fluids, contact with skin-irritating materials. Normally, a skin-protecting active substance also has a simultaneous skin-caring function. The term skin-healing or the skin-healing attribute in the context of this invention can be most readily defined in reference to the condition of the healthy human skin. Healthy human skin is characterized in that its intact acid boundary surface provides an adequate protection against microorganisms, germs and pathogens, that its buffer capacity and its capacity for neutralizing alkalis adequately protect against harmful effects of ambient fluids, that to a large extent there is freedom from reddening, and that it is free from cuts, scrapes and bums, irritations, inflammations and allergies as well as that it is neither wrinkled nor dried out. Healthy skin is further characterized in that it assumes a depot function for fat, water and blood and plays an important role in metabolism. When the skin no longer assumes the above functions or shows obvious lesions or there is itchiness, then it is no longer classified as healthy. In the scope of the present invention, skin healing is thus all that helps the skin to revert to its original condition. Accordingly, skin healing is also everything that stimulates, entrains, supports and assists the self-regulation of the skin, such that it can fulfil its functions and enables it to revert to its natural equilibrium state. In the context of this invention, the term skin healing is further understood to mean all influences that enable obvious skin illnesses, such as for example eczema, rashes, reddening, itchiness, swelling, vesiculation, discharges, scabs in the most different forms, to be at least soothed if not even healed. Normally, a skin-healing active substance also has a simultaneous skin-protecting and skin-caring function.

As already intimated, in the context of the inventive use, the good dissolvability of the microemulsion is a significant advantage of the subject matter of the invention. The dissolvability of the microemulsion and its dispersability even in cold water are precisely particularly good when the droplet size neither exceeds specific maximum values nor falls below specific minimum values. Advantageously, such microemulsions are also particularly stable.

Microemulsions with a droplet size d₅₀ not greater than 400 nm, preferably not greater than 300 nm, advantageously not greater than 250 nm, further advantageously not greater than 200 nm, even more advantageously not greater than 150 nm, in particular not greater than a value of 100 nm are consequently particularly preferred and accordingly the use of these preferred microemulsions illustrates a particularly advantageous embodiment of the invention.

Likewise, it is extraordinarily advantageous for the dissolvability of the microemulsion and its dispersability even in cold water when the droplet size is not below specific minimum values.

Microemulsions with a droplet size d₅₀ not smaller than 10 nm, preferably not smaller than 25 nm, advantageously not smaller than 40 nm, particularly not falling below a value of 60 nm, are consequently particularly preferred and accordingly the use of these preferred microemulsions illustrates a particularly advantageous embodiment of the invention.

A preferred embodiment of the invention is likewise illustrated by the use of an inventive microemulsion that comprises the cationic polymer preferably in amounts of less than 10 wt. %, advantageously less than 5 wt. %, further advantageously less than 3 wt. %, extremely advantageously in amounts of less than 1 wt. %, in particularly, however, in amounts of less than 0.5 wt. %, wherein preferably a lower limit of 0.05 wt. %, advantageously 0.1 wt. % is not exceeded. Advantageously, cationic polymers are also able to contribute to the stability of the microemulsion and at the same time render a service to the treated fabric and the skin, in that they can be absorbed as a wafer-thin film onto the fabric fibers during the fabric treatment. Thus, the optical appearance of the fabric can be enhanced due to its silky glossy appearance, and the fabric is protected against harmful environmental influences by the film. The fabric/skin contact demonstrates an improved feel of the fabric. In addition, the cationic polymer, on contact of the treated fabric with the skin, can also be at least partially transferred onto the skin, such that the skin itself is directly protected by a cationic polymer film.

In the context of the invention, particularly advantageous cationic polymers are polymeric quaternary ammonium compounds, preferably selected from copolymers of quaternized vinyl imidazole and vinyl pyrrolidone, copolymers of vinyl caprolactam, vinyl pyrrolidone and quaternized vinyl imidazole and/or quaternized copolymers of vinyl pyrrolidone and dimethylaminoethyl methacrylates. A particularly preferred polymer is the 3-methyl vinyl imidazoline chloride/vinyl pyrrolidone copolymer, obtainable as Luviquat® Excellence from BASF AG.

As already described, an important advantage of the subject matter of the invention is that as a result of the inventive use, a fabric treated with a suitable microemulsion is beneficial to skin health. It is therefore advantageous when the microemulsions used according to the invention include additional ingredients that are beneficial to the well being of the skin.

One ingredient that in this context is likewise beneficial is urea and/or its derivatives. Urea and/or its derivatives promote skin health as they can act antimicrobially, as water binders, calmants for itching, can dislodge skin scale, act as skin smoothers as well as being able to inhibit excessive cell growth. Moreover they can serve as moisturizers, i.e. the can help the skin to conserve moisture.

The microemulsions to be used according to the invention can therefore comprise urea and/or its derivatives.

Advantageously, the microemulsions to be used according to the invention can incorporate moisturizers, for example those selected from the following group: Amino acids, chitosan or chitosan salts/derivatives, ethylene glycol, glucosamine, glycerin, diglycerin, triglycerin, uric acid, honey and hydrogenated honey, polyaspartic acid, creatinine, cleavage products from collagen, lactitol, polyols and polyol derivatives (for example butylene glycol, erythritol, propylene glycol, 1,2,6-hexanetriol, polyethylene glycols like PEG-4, PEG-6, PEG-7, PEG-8, PEG-9, PEG-10, PEG-12, PEG-14, PEG-16, PEG-18, PEG-20), pyrrolidone carboxylic acid sugar and sugar derivatives (for example fructose, glucose, maltose, maltitol, mannitol, inositol, sorbitol, sorbityl silane diol, -suerose, trehalose, xylose, xylitol, glucuronic acid and its salts), ethoxylated sorbitol (Sorbeth-6, Sorbeth-20, Sorbeth-30, Sorbeth-40), hydrogenated starch hydrolyzates as well as mixtures of hydrogenated wheat protein and PEG-20-acetate copolymer, particularly panthenol. As such microemulsions particularly help to regulate the moisture in the skin, they are very advantageous and the use of such microemulsions is a preferred embodiment of the invention.

The cited moisturizers are consequently advantageous as they can contribute to regulate the moisture content of the skin. It is known that fabrics that commonly exhibit a certain absorbency can, on contact with the skin, remove moisture from the skin. Consequently, the simple wearing of washing that is in direct contact with the body means that moisture can be removed from the skin. The presence of moisturizers in the microemulsion can now advantageously lead at least to a compensation of this loss, if not to an over-compensation. Again, the fabric, treated with the microemulsion in the course of a wash in an automatic washing machine, serves as a temporary host, in that firstly it takes up the moisturizing substances and then transfers them to the skin on contact with the skin, in particular by rubbing against the skin. It is particularly advantageous to supply the skin not only with oils or lipids but also with moisturizers by means of the treated fabric. Particularly irritated skin can be advantageously relieved in this way as the action of the oils and the moisturizers is strongly reinforced.

In the overall context of the invention, it is additionally very advantageous if the used microemulsions comprise sequestering agents.

Microemulsions which comprise the sequestering agents, preferably selected from the group of citrates, citric acid, gluconates, gluconic acid, phosphates, phosphonates, carboxylates, ethylenediaminetetraacetic acid and/or its salts, nitrilotriacetic acid and/or its salts, diethylenetriaminepentaacetic acid and/or its salts, propylenediaminetetraacetic acid and/or its salts, alaninediacetic acid and/or its salts, methylglycinediacetic acid and/or its salts, iminodisuccinic acid and/or its salts, and/or the trisodium salt of the ethylenediamine-N,N′-disuccinic acid, wherein the citrates and/or citric acid are the most preferred, are therefore particularly advantageous and consequently the use of these particularly advantageous microemulsions illustrates a particularly preferred embodiment of the invention.

In this respect, the sequestering agents are preferably present in defined proportions.

Microemulsions that comprise the sequestering agent in amounts of at least 1.5 wt. %, advantageously at least 2.5 wt. %, further advantageously in amounts of at least 4 wt. %, extremely advantageously in amounts of at least 6 wt. %, in particularly, however, in amounts of at least 7.5 wt. %, wherein preferably an upper limit of 25 wt. %, advantageously 20 wt. %, further advantageously of 17 wt. %, more advantageously of 15 wt. %, preferably 12 wt. % is not exceeded are particularly advantageous in the scope of the invention and consequently a particularly preferred embodiment of the invention is illustrated by the use of these particularly advantageous microemulsions.

Against the background of the invention to provide the consumer with an alternative possibility of treating fabrics, in which, as was described, not only the fabric is provided with a soft hand, but in which also a benefit is provided to the skin, principally citric acid and/or citrates are very helpful as the sequestering agents, as they also have a skin-functional basis.

The ingredients citric acid and/or citrates serve, inter alia, to support or to renew the natural acid protective boundary surface or hydrolipidic film of the skin. The hydrolipidic film of the skin is attacked or destroyed by alkaline influences, resulting in a loss of the skin's barrier function, such that microorganisms or noxious substances can penetrate the skin more easily. For example, the residual alkali in the clothes can be eliminated by means of citric acid in the inventive agents, and the pH of the fabrics adjusted to a pH of e.g. about 5. In addition, water hardness and dirt are bound or complexed by the citric acid and/or citrate. Moreover, citric acid and citrates are completely biologically decomposable to the inorganic products carbon dioxide and water.

Microemulsions, in which at least citrate(s) and/or at least citric acid are comprised, preferably exclusively citrate(s) and/or citric acid, wherein the citrate(s) and/or citric acid are advantageously comprised in amounts of 1 wt. % to 16 wt. % as the sequestrant, are particularly advantageous and consequently the use of these particularly advantageous microemulsions illustrate a particularly preferred embodiment of the invention.

The oil comprised in the microemulsion plays an important role both in the softening of the fabric being treated and especially concerning the described connection with the skin.

In this connection it is particularly advantageous that the oil comprised in the microemulsion is selected from the group of the totally synthetic oils, preferably silicone oils, natural oils, such as preferably vegetal and/or animal fatty oils, and/or ethereal oils, and consequently the use of these preferred microemulsions illustrates a particularly advantageous embodiment of the invention.

In a further particular embodiment a skin-protecting material is used. Advantageously, these skin-protecting materials are a skin-protective oil, e.g. also a carrier oil, particularly selected from the group algea oil oleum phaeophyceae, aloe-vera oil aloe vera brasiliana, apricot nut oil prunus armeniaca, arnica oil arnica montana, avocado oil persea americana, borage oil borago officinalis, calendula oil calendula officinalis, camellia oil camellia oleifera, thistle oil carthamus tinctorius, echium oil, peanut oil arachis hypogaea, hemp oil cannabis sativa, haselnut oil corylus avellana/, St. John's wort oil hypericum perforatum, jojoba oil simondsia chinensis, carrot oil daucus carota, oil of blackcurrant seeds, cocoa oil cocos nucifera, pumpkinseed oil curcubita pepo, corn nut oil aleurites moluccana, macadamia nut oil macadamia ternifolia, almond oil prunus dulcis, evening primrose oil, olive oil olea europaea, peach nut oil prunus persica, colza oil brassica oleifera, castor oil ricinus communis, nutmeg flower oil nigella sativa, sesame oil sesamium indicum, sunflower oil helianthus annus, grapeseed oil vitis vinifera, trichodesma oil, walnut oil juglans regia, wheat germ oil triticum sativum, wherein from these, especially borage oil, hemp oil and almond oil are particularly advantageous.

All the abovementioned oils are natural emollients, i.e. materials that make the body tissue softer and more supple and which reduce the roughness of the skin. These oils therefore, are first of all also skin caring. Secondly, these oils have additional specific effects that entail a synergistic interaction with the skin and provide a protection under adverse conditions.

A similarly preferred oil is almond oil. It is characterized in that it can strengthen the effect of other oils and is therefore advantageously employed in combination with other oils. However, the use of almond oil in the microemulsion without adding additional fatty oils can also be preferred. The emulsifying system comprised in the microemulsion is particularly advantageous for the stability and also for the dissolvability of the microemulsion being used according to the invention.

In this respect, particularly preferred microemulsions are those whose emulsifiers are selected from the group of cationic, non-ionic, zwitterionic, ampholytic and/or anionic emulsifiers, and consequently the use of these preferred microemulsions illustrates a particularly advantageous embodiment of the invention.

The applicant has surprisingly found that the microemulsions then precisely demonstrate very advantageous properties in regard to the stability and also to their dissolvability, when they comprise specific emulsifiers.

Microemulsions, in which at least one cationic emulsifier is comprised, advantageously a lipophilic cationic emulsifier, are particularly advantageous in this respect and consequently the use of these particularly advantageous microemulsions illustrates a particularly preferred embodiment of the invention. Such microemulsions are particularly stable.

As has already been described, the microemulsion used in accordance with the invention includes not only one emulsifier. It is of great benefit for the stability and the dissolvability of the microemulsions when in addition to at least one cationic emulsifier, there is also a non-ionic, preferably non-ionic hydrophilic emulsifier present.

Microemulsions, in which at least one non-ionic emulsifier is comprised, in particular a hydrophilic non-ionic emulsifier, wherein if a cationic emulsifier is comprised at the same time, the weight ratio of cationic to non-ionic emulsifier is advantageously in the range 70:1 to 3:1, particularly 50:1 to 8:1, preferably 30:1 to 10:1, and particularly preferably 20:1 to 12:1, are in this respect particularly preferred, and consequently the use of these preferred microemulsions illustrates a particularly advantageous embodiment of the invention. Such microemulsions are particularly stable and very well dispensable from the dispensing draw of a washing machine, in particular also from the compartment for the after-treatment agent (e.g. softeners), in which use is normally made of the siphon effect. The siphon effect is briefly discussed below.

The dispensability and the stability of the microemulsions can actually be improved even more when quite specific non-ionic emulsifiers are added.

Microemulsions, in which the non-ionic emulsifier therein comprised is selected from ethoxylated fatty alcohols and/or ethoxylated fatty acid alkanolamides, are particularly advantageous in this respect and consequently the use of these particularly advantageous microemulsions illustrates a particularly preferred embodiment of the invention. Particularly preferred in regard to the ethoxylated fatty alcohols, are the addition products of 5 to 40 ethylene oxide units onto C₈₋₂₂ fatty alcohols, wherein in particular, Eumulgin® B3 (cetylstearyl alcohol+30 EO; available from Cognis Germany GmbH) is extremely preferred. Particularly preferred in regard to the ethoxylated fatty acid alkanolamides are preferably the ethoxylated cocofatty acid monoethanolamide, in particular cocofatty acid monoethanolamide plus 4 ethylene oxide units, as corresponds, for example to the commercial product Eumulgin® C4 (available from Cognis Germany GmbH). By the use of non-ionic emulsifiers corresponding to this preferred embodiment, in particular by the use of Eumulgin B3, inventive microemulsions with outstanding stability, outstanding dispensability and outstanding dispersability in water can be prepared.

Likewise, the dispensability and stability of the microemulsions to be used according to the invention can be even further improved when quite specific cationic emulsifiers are used at the same time.

Microemulsions, in which the cationic emulsifiers therein comprised are quaternary ammonium compounds, advantageously alkylated quaternary ammonium compounds, preferably with one, two or three hydrophobic groups that are in particular linked through ester or amido bonds with a quaternized di- or triethanolamine or an analogous compound are particularly advantageous in this respect and consequently the use of these particularly advantageous microemulsions illustrates a particularly preferred embodiment of the invention.

Microemulsions in which the cationic emulsifier therein comprised is a quaternary ammonium compound, selected from the following Formulae (I): 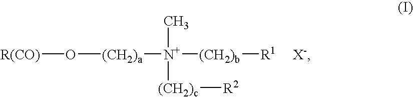
wherein R stands for an aliphatic group with 12 to 22 carbon atoms with 0, 1, 2 or 3 double bonds; R¹ stands for H, OH or particularly O(CO)R⁴, R² stands independently of R¹ for H, OH or O(CO)R⁵, wherein R⁴ and R⁵ independently of one another each stands for an aliphatic alkyl group with 12 to 22 carbon atoms with 0, 1, 2 or 3 double bonds, a, b and c independently of each other can each have the value 1, 2 or 3, X⁻ is a suitable anion, preferably a halide, methosulfate, methophosphate or phosphate ion as well as mixtures thereof,

and/or the Formula (II): 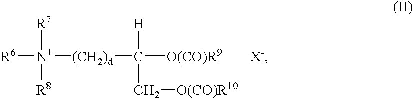
wherein R⁶, R⁷ and R⁸ independently of each other stands for a C₁₋₄alkyl, alkenyl or hydroxyalkyl group, R⁹ and R¹⁰, each independently selected, represent a C₈₋₂₈ alkyl group with 0, 1, 2 or 3 double bonds and u is a number between 0 and 5, X⁻ is a suitable anion, preferably a halide, methosulfate, methophosphate or phosphate ion as well as mixtures thereof,

are very advantageous in the context of the invention, and consequently the use of these very advantageous microemulsions illustrates a particularly preferred embodiment of the invention.

Microemulsions in which the cationic emulsifiers comprised therein are N-methyl-N(2-hydroxyethyl)-N,N-(ditallowacyloxyethyl)ammonium methosulfate or N-methyl-N(2-hydroxyethyl)-N,N-(dipalmitoylethyl)ammonium methosulfate are very advantageous, and consequently the use of these very advantageous microemulsions illustrates a particularly preferred embodiment of the invention.

The content of cationic emulsifier, preferably lipophilic cationic emulsifier, can be advantageously adjusted.

Microemulsions that comprise less than 20 wt. %, preferably less than 15 wt. %, advantageously less than 10 wt. %, very advantageously less than 5 wt. %, further advantageously less than 4 wt. %, even further advantageously less than 3.5 wt. %, extremely advantageously less than 3 wt. %, exceedingly advantageously less than 2.5 wt. %, most advantageously less than 2 wt. %, at least, however, 0.1 wt. %, advantageously at least 0.5 wt. %, in particular at least 1 wt. % of cationic, preferably lipophilic cationic emulsifiers, are exceedingly advantageous and consequently the use of these exceedingly advantageous microemulsions illustrates a particularly preferred embodiment of the invention.

The content of non-ionic, preferably hydrophilic non-ionic emulsifiers can also be advantageously adjusted.

A microemulsion that comprises less than 5 wt. %, preferably less than 3 wt. %, advantageously less than 2 wt. %, very advantageously less than 1.5 wt. %, further advantageously less than 1.0 wt. %, even further advantageously less than 0.75 wt. %, extremely advantageously less than 0.6 wt. %, exceedingly advantageously less than 0.45 wt. %, most advantageously less than 0.35 wt. %, at least, however, 0.15 wt. %, advantageously at least 0.2 wt. %, in particular at least 0.25 wt. % of non-ionic, preferably hydrophilic non-ionic emulsifiers, is rated in the context of the invention as exceedingly advantageous, such that the use of these exceedingly advantageous microemulsions illustrates a particularly preferred embodiment of the invention.

The significance of the oils in the context of the invention has already been pointed out. According to the state of knowledge of the applicant, it is the case that the microemulsions to be used according to the invention are precisely very advantageous in regard to the dispensability, the stability and also in regard to the skin health, when specific quantity levels are adhered to.

Microemulsions, which comprise at least 0.5 wt. %, preferably at least 2.5 wt. %, advantageously at least 5 wt. %, particularly 10 wt. %, however not more than 50 wt. %, preferably not more than 45 wt. %, advantageously not more than 40 wt. %, very advantageously not more than 35 wt. %, even more advantageously not more than 32 wt. %, exceedingly advantageously not more than 28 wt. %, most advantageously not more than 25 wt. % of oils, each based on the total microemulsion, are to be classified as very advantageous, such that the use of these very advantageous microemulsions illustrates a particularly preferred embodiment of the invention.

With the principal aim of further improving the stability of the microemulsions, they can comprise thickeners.

A microemulsion, which comprises at least 0.05 wt. %, preferably at least 0.1 wt. %, advantageously at least 0.15 wt. %, particularly at least 0.2 wt. %, however not more than 10 wt. %, preferably not more than 3 wt. %, advantageously not more than 2.5 wt. %, very advantageously not more than 2.0 wt. %, even more advantageously not more than 1.5 wt. %, exceedingly advantageously not more than 1.0 wt. %, particularly not more than 0.75 wt. %, most advantageously not more than 0.5 wt. % of hydrophilic and/or lipophilic thickeners, are in this sense to be classified as very advantageous, such that the use of these very advantageous microemulsions illustrates a particularly preferred embodiment of the invention.

The thickener comprised in the microemulsion is preferably selected from the group of the
a) polysaccharides, in particular xanthane gum, guar derivatives, gum arabicum, karaya gum, traganth, taragum, gellan, carrageen, locust bean flour, agar agar, alginates, pectins and/or dextrans,
b) organic synthetic thickeners, particularly polyacrylates, polyacrylamides, polyvinyl pyrrolidone, polyvinyl alcohol, polyethylene glycols, hydrophobically modified polyethers, polyurethanes, styrene-maleic anhydride copolymers, their salts and/or derivatives,
c) non-ionic and/or anionic cellulose derivatives, particularly hydroxyethyl cellulose, carboxymethyl cellulose, hydroxypropyl methyl cellulose, hydroxypropyl cellulose, ethyl hydroxyethyl cellulose, methyl cellulose,
d) Starch fractions and derivatives, particularly amylose, amylopectin and dextrins,
e) clays, particularly bentonite.
f) fatty acids, fatty alcohols, silicone oils, waxes,
g) mixtures of the above
   and the corresponding microemulsions are very advantageous, principally in regard to the stability of the emulsion, and consequently the use of these very advantageous microemulsions is a particularly preferred embodiment of the invention.

In this regard, fatty acids are exceedingly preferred thickeners. They can not only further stabilise the emulsion, but surprisingly, the combination of oils and the fatty acids causes the oils to be even better absorbed onto the treated textiles. The fatty acids can increase the efficiency of the oil loading of the fabrics such that nearly 100 percent of the oil comprised in the microemulsion can be deposited onto the fabric during the fabric treatment. Accordingly, the microemulsions advantageously comprise fatty acid(s) in amounts of up to 10 wt. %, further advantageously in amounts of up to 5 wt. %, particularly in amounts between 2 and 4 wt. %. Here, C12-C16 fatty acids are particularly suitable, in particular myristic acid.

The microemulsions to be used in accordance with the invention advantageously comprise water as the dispersion agent, in which the oil phase is preferably dispersed. The water content can be advantageously adjusted.

A microemulsion, which comprises at least 40 wt. %, preferably at least 45 wt. %, advantageously at least 50 wt. %, however not more than 90 wt. %, preferably not more than 85 wt. %, advantageously not more than 80 wt. %, very advantageously not more than 75 wt. %, even more advantageously not more than 70 wt. %, exceedingly advantageously not more than 68 wt. %, most advantageously not more than 65 wt. % of water, each based on the total agent, are advantageous and consequently the use of these advantageous microemulsions is a particularly preferred embodiment of the invention.

As already described, the comprised oils not only serve to soften the fabric, but also serve in the active, temporary host fabric to provide a benefit to the skin. This benefit is precisely very advantageous when the oils possess specific properties.

Microemulsions that comprise at least one oil with skin protecting and/or skin caring and/or skin healing properties are particularly advantageous in this regard; consequently the use of these particularly advantageous microemulsions is a particularly preferred embodiment of the invention.

Likewise, microemulsions, in which at least one of the oils comprised in the microemulsion has an antiseptic effect, are advantageous, such that, consequently, the use of these advantageous microemulsions illustrates a particularly preferred embodiment of the invention. In the context of this invention, the attribute “antiseptic effect” is understood to mean an activity that serves the self-regulatory forces of human skin. This effect in its specificity is not to be compared with that of the classical disinfectants or germicides such as e.g. phenols, halides, alcohols with which e.g. skin and mucous membranes, wounds or also medical instruments are treated to attain asepsis (sterility). The classical antiseptic includes antimicrobial measures at the place of exit or at the port of ingress of a possible infection or source of infection at the body surface. However, in the context of the invention, a strong effect of this type is not the objective, as although it would indeed lead to an elimination of harmful germs or the like, it would also impair the natural skin flora of the person.

The particular advantage of the antiseptic active materials employed according to the invention results from a synergistic cooperation of these substances with the general functional mechanisms of human skin, as these mildly antiseptic substances reduce e.g. germs, including harmful germs, but do not completely destroy them, i.e. not as far as sterility. In consequence, enough germs remain on the skin in sufficient numbers to assist and thereby strengthen the self-regulatory forces of the human skin. The cooperation of the self-regulatory forces of the skin with the antiseptic power of the active material in the agent reinforces the general functional mechanisms of the skin. This is of great importance, especially in regard to already irritated and/or otherwise damaged skin. For already irritated and/or sensitized and/or otherwise damaged or even particularly sensitive skin, the self-regulatory forces of the skin are partially no longer capable, even if only temporarily, to assure the skin health on their own. The synergistic cooperation with the agents to be employed according to the invention supports, assists and strengthens these self-regulatory forces. In this way the fabric treatment agent or the washing treated with them supports the natural skin flora of humans.

In order not to impair the natural skin flora of humans, it is important to rule out as far as possible such materials that are strong disinfectants or antiseptics, such as e.g. glutaraldehyde, which simultaneously exhibit a high allergizing potential and are irritants to skin and mucous membranes.

The oils with antiseptic activity preferably are ethereal oils that are particularly selected from the group of angelica fine—angelica archangelica, aniseed—pimpinella anisum, benzoe siam—styrax tokinensis, cabreuva—myrocarpus fastigiatus, cajeput—melaleuca leucadendron, cistrose—cistrus ladaniferus, copaiba-balsam—copaifera reticulata, costic root—saussurea discolor, edeltannennadel—abies alba, elemi—canarium luzonicum, fennel—foeniculum dulce pine-needle—picea abies, geranium—pelargonium graveolens, ho-leaves—cinnamonum camphora, immortals (straw flower) helichrysum ang., ginger—zingiber off., St. John's wort—hypericum perforatum, jojoba, German chamomile—matricaria recutita, chamomile—matricaria chamomilla, Roman chamomile.—anthemis nobilis, wild chamomile—ormensis multicaulis, carrot—daucus carota, knee pine—pinus mugho, lavander—lavendula hybrida, litsea cubeba—(may chang), manuca—leptospermum scoparium, balm mint—melissa officinalis, pine tree—pinus pinaster, myrrh—commiphora molmol, myrtle—myrtus communis, neem—azadirachta, niaouli—(mqv) melaleuca quin. viridiflora, palmarosa—cymbopogom martini, patchouli—pogostemon patschuli, perubalsam—myroxylon balsamum var. pereirae, raventsara aromatica, rose wood—aniba rosae odora, sage—salvia officinalis horsetail—equisetaceae, yarrow—achillea millefolia, narrow leaf plantain—plantago lanceolata, styrax—liquidambar orientalis, tagetes (marigold) tagetes patula, tea tree—melaleuca altemifolia, tolubalsam—myroxylon balsamum 1., virginia-ceder—juniperus virginiana, frankincense (olibanum)—boswellia carteri, silver fir—abies alba.

A further advantage of the above listed ethereal oils is their particular multifunctionality, which besides the described mild antiseptic activity exhibit a number of additional desirable organoleptic properties that are specifically imputed to these oils. In most cases these oils have an expectorant effect as they provoke a mildly positive irritation on the mucous membranes of the respiratory system Moreover, a desirable warm sensation can arise. Deodorant, analgesic, circulation enhancing, calming effects could be observed by the applicant in connection with the inventive employment of these identified oils and identified as being particularly advantageous. In this context, the organoleptic properties of these oils are generally not due to the main components, but rather from the secondary or trace constituents that can be in their hundreds and interact synergistically with each other. Another advantage associated with the cited oils is due to their harmonious fragrance and odor, which in many cases lead to a positive feeling in humans.

In this manner, the fabric treatment agent or the treated washing not only supports the natural skin flora of humans but also provides the human being with additional advantages of the type just described.

A microemulsion, in which at least one of the comprised oils exhibits a minimum content of γ-linolenic acid of 0.1 wt. %, based on the oil in question, is particularly advantageous for the invention, and in particular, at least one of the oils, preferably at least two of the oils are selected from hemp oil, borage oil, evening primrose oil, blackcurrant seed oil, echium oil, trichodesma oil and/or albarakka oil. Accordingly, the use of these particularly advantageous microemulsions is a particularly preferred embodiment of the invention.

In the context of this invention, a particularly preferred oil is e.g. hemp oil. Hemp oil, which possesses a high content of essential fatty acids, and moreover comprises up to 6 wt. % of the valuable γ-Linolenic acid (GLA), also acts as an anti-inflammatory, weakly analgesic, healing, caring, improver of skin structure, preventing aging effects. It improves renewal processes in the tissue and promotes a high regenerative action in damaged tissue. In addition, it can increase the healing properties or other properties of other oils, particularly all the oils specifically mentioned here. Because they help to regulate and normalize the transepidermal water loss over the skin, essential fatty acids play an important part in maintaining the skin barrier function in the context of the invention, the hemp oil playing a particular role due to its high GLA content, as a local treatment of malfunctioning transepidermal water loss with GLA leads to the strongest reduction of the transepidermal water loss.

In the context of this invention, a similarly preferred oil is borage oil. As a result of its high GLA content (up to 25 wt. %), it has comparable properties and advantages as those of hemp oil. The same applies to the evening primrose oil that is also a preferred oil.

If the pH of the microemulsion, particularly the pH of a 1 % aqueous solution of the microemulsion at a temperature of T=20° C. is not greater than 6.5, preferably not greater than 5.5, then this is a preferred microemulsion and consequently the use of these particularly preferred microemulsions is a particularly advantageous embodiment of the invention.

A pH of the microemulsion (fabric treatment agent) between 2 and 6.5, preferably between 3-5.5, measured at a temperature of 20° C. in particular of a 1 % aqueous solution of the fabric treatment agent is advantageous in regard to the pH of the skin of a healthy person. Such microemulsions are preferred.

As the skin surface in the region of the large sweat glands, present in the genital area and in the armpits, is only weakly acidic (pH 5.5-6.5), there exists precisely there a reduced defence capability against germs or bacteria, such that in the context of the invention, it is particularly advantageous if the pH of the fabric treatment agent is not greater than 5.5, measured at a temperature of 20° C. in a 1% aqueous solution of the fabric treatment agent.

A further advantage of this pH range for the fabric treatment agent is seen in relation to body hygiene. When the body is washed with soap, then the pH of the washed skin is increased to about 9, such that the natural protective coat of the skin is massively disturbed. The self-regulatory forces of the skin allow the skin to regain its acidic pH. Indeed, this process can require up to 3 hours, however, usually at least 30 minutes. This differs from skin type to skin type and occurs e.g. very slowly for children.

Such a pH range is particularly advantageous in regard to a subgroup of people with particularly sensitive skin, such as babies or infants, or a subgroup of people with pre-existing skin problems, e.g. allergies. Baby skin, for example is markedly thinner than adults' skin. As the production of tallow from baby skin is markedly reduced, it exhibits only a partial barrier function and a very thin hydrolipidic film. There therefore exists a particular need in this case for the inventive fabric treatment agent.

The advantage of the fabric treatment agent with a pH as described before is that the fabrics treated with it are capable of supporting the self-regulatory forces in their alkali-neutralization ability in so far as the fabric that is in contact with the skin, such as e.g. a wipe or underclothes has a skin-optimum pH. In this way the fabric treatment agent or the washing treated with them supports the natural skin flora of humans.

It is further advantageous when the agents to be used according to the invention are exempt from dyestuffs, although commercially available dyestuff-containing agents can lead to slight skin irritations only in extremely rare cases or with particularly disposed, extremely sensitive people. Therefore, in order to reduce even more the possibility of the hypothetically present tendency to incompatibility, it is accordingly advantageous to minimize the dyestuff content in the agents to be used according to the invention, best of all to colorant free. If dyestuffs are required, for example on visual grounds then the normal dyestuffs are employed. Preferably, the dyestuff content is below 0.002 wt. % of the composition, particularly 0 wt. %.

Thus, when the microemulsion is exempt from dyestuffs, it is an advantageous microemulsion and accordingly, the use of these particularly advantageous microemulsions is a particularly preferred embodiment of the invention.

Likewise, microemulsions that comprise only natural aromas, however, preferably no additional fragrances or perfume oils, are of great advantage, such that the use of such microemulsions also illustrates a particularly preferred embodiment of the invention.

This is particularly advantageous, as eventual specific fragrances or perfume oils, which are not skin-healing, skin caring and/or skin protecting active substances in the sense of the invention and are not natural aromas, can provoke, if only in a very small subgroup of persons with exceptionally sensitive skin and corresponding predispositions to minor, subjectively felt reactions of incompatibility that would work against the present invention.

Indeed, the inventive agents are preferably free of the cited odiferous compounds, however, it may be desired to produce a particularly appealing fragrant note that can not be solely generated from the inventive active materials and their inherent odors. Accordingly, in a preferred embodiment it is possible to incorporate a small amount of such odiferous compounds, which are not active materials in the sense of the invention, into the agents in question.

Typical synthetic fragrances or odiferous compounds or perfume oils include for example synthetic products of the type of the esters, ethers, aldehydes, ketones, alcohols and hydrocarbons. Odiferous compounds of the ester type are, for example, benzyl acetate, phenoxyethyl isobutyrate, p-tert.-butylcyclohexyl acetate, linalyl acetate, dimethylbenzyl carbinyl acetate, phenylethyl acetate, linalyl benzoate, benzyl formate, ethylmethylphenyl glycinate, allylcyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, o-isomethyl ionone and methyl cedryl ketone; the alcohols include anethol, citronellol, eugenol, geraniol, linalool, phenylethyl alcohol and terpineol and the hydrocarbons include, above all, the terpenes, such as limonene and pinene. The perftime oils can also comprise mixtures of odiferous compounds, as are obtainable from vegetal sources, e.g. pine oil, muscatel, oil of cloves, cinnamon leaf oil, lime blossom oil, juniper berry oil, vetivert oil, galbanum oil, laudanum oil as well as orange blossom oil, orange peel oil.

When the microemulsion comprises an easy ironing agent and/or an anti-crease agent, it is an advantageous microemulsion and accordingly, the use of these microemulsions is also a particularly preferred embodiment of the invention. The advantage of this embodiment is that the ironing time can be reduced by the easy ironing agent and the anti-crease agent such that the valuable ingredients of the inventive fabric treatment agent are not subjected to long thermal stress and therefore retain their full efficiency.

The microemulsions can advantageously comprise deodorants, such that the use of such microemulsions is a particularly preferred embodiment of the invention.

In this respect it must be noted that many of the already cited oils, in particular the ethereal oils, also have an inherent deodorant effect. The particular advantage of incorporating one or a plurality of deodorants in the inventive fabric treatment agent is that these active principles, together with the cited oils, bring a particularly strong, because synergistic, effect in regard to the deodorizing activity. In this respect the effectiveness is only one aspect of the masking of malodorous or unpleasant smells. In connection with the action of the agent on the skin, resulting from the contact skin/treated fabric, there appears an additional effect that alludes to the synergistic interaction of the active principles in the sense of the invention with the added deodorants and with the self-regulatory forces, such that not only the symptom, the malodor, is eliminated, rather the cause of the odor. Generally, this concerns bacteria that have settled in different numbers on the skin or in the hair or pubic hair regions. These bacteria are capable of decomposing proteins and fats, e.g. from body sweat, into malodorous sulfur compounds. These bacteria are efficiently counteracted by the synergistic cooperation of the abovementioned factors. The self-regulatory forces of the skin are simultaneously stimulated and developed.

A microemulsion, which comprises a terpene-containing plant extract, preferably an extract of parts of plants from one or a plurality of plants from the family of the Myrtacae, wherein the extract is advantageously tea tree oil, wherein the extract is particularly comprised in an amount of at least 0.006 wt. % to maximum 1 wt. % in the microemulsion, can be considered as being particularly advantageous, such that in consequence the use of such microemulsions also illustrates a particularly preferred embodiment of the invention.

The tea tree oil is of great importance for the subject matter of the invention, as it unites germicidal, antiseptic, fungicidal, antiviral, wound healing, inflammation inhibiting, scar promoting effects.

If the microemulsion comprises at least 0.03 wt. %, advantageously 0.04 to 4 wt. %, preferably 0.1 to 1.5 wt. %, particularly 0.05 to 1 wt. % of natural antioxidants, in particular selected from terpene-containing antioxidants, vitamin E, vitamin C, vitamin A, selenium and/or their derivatives or mixtures, then consequently, in the context of this invention, the use of such microemulsions is also a particularly preferred embodiment of the invention. The addition of antioxidants greatly contributes to the product stability. The applicant was able to discover that this also applies to the stability of the oil that is found on the treated fabric fibers subsequent to the fabric treatment. If an inventive microemulsion does not comprise antioxidants, then the content of C18:2 (linoleic acid, measured as its methyl ester) declines to about half of the original value after a 4-week storage of the treated fabric. In contrast, for a microemulsion with a tocopherol content of 0.2 wt. %, no reduction of C18:2 content was observed on the fibers.

Vitamin E (the collective term for chemical compounds from the group of the tocopherols) is particularly predestined as the antioxidant. It was surprisingly discovered that fabrics that were treated with an inventive vitamin E-containing microemulsion are advantageous in regard to the prevention of body odor resulting from sweat secretion. It was determined that the secreted sweat did not involve any fetor, which is very advantageous. The freedom from fetid odors concerned both the fabric and the skin. Fetid odors are therefore counteracted without the sweating being suppressed. The vitamin E is advantageously comprised in quantities of less than 1.5 wt. %.

The use of inventive microemulsions that comprise an acidic buffer, preferably an organic buffer system that buffers the microemulsion and the fabric treatment bath preferably in a pH range of 2 to 6.5, particularly 3 to 5.5, also illustrates a preferred embodiment of the invention. The advantage of an acidic buffer is that it contributes to the stability of the microemulsion.

Advantageously, the buffer system comprises acids, in particular selected from formic acid, citric acid, acetic acid, sulfonic acid—advantageously amidosulfonic acid—and/or their derivatives or mixtures thereof.

If the buffer system comprises at least one salt of the acid(s) comprised in the buffer system, preferably sodium citrate, then it is likewise preferred.

According to a further preferred embodiment of the invention, the buffer system comprises polyacrylates, polymethacrylates and/or copolymers of acrylic acid and maleic acid, preferably with a molecular weight of 2000 to 10 000.

A microemulsion that comprises additional non-aqueous solvents, preferably hydroxy-derivatives of aliphatic and alicyclic hydrocarbons, in particular ethanol, advantageously in amounts greater than 0.5 wt. %, very advantageously in amounts greater than 1 wt. %, wherein, however, a maximum of 10 wt. %, preferably 7.5 wt. %, particularly 4 wt. % is not exceeded, is regarded as being advantageous, such that consequently, the use of such microemulsions is also a particularly preferred embodiment of the invention.

If formic acid and/or its salts are used, preferably in amounts of less than 0.15 wt. %, advantageously less than 0.1 wt. %, particularly less than 0.075 wt. %, then it is advantageous and likewise the use of such microemulsions is advantageous and illustrates a particularly preferred embodiment of the invention. Formic acid can further increase the stability of the microemulsion, essentially with regard to a conservation.

If lactic acid and/or its salts are comprised in the microemulsion, preferably in amounts of less than 5 wt. %, advantageously less than 3 wt. %, particularly less than 2 wt. %, then it is advantageous, as lactic acid and/or its salts are functionally active to the skin. Lactic acid is an important and moisture-binding ingredient of an intact outer skin. Added externally, lactic acid can actually improve the water-binding capacity of the skin. The skin-smoothing property of lactic acid has also a positive influence on our skin appearance. As lactic acid supports the loosening of skin scales (Keratolysis) it provides for a smooth, regular skin. This characteristic is mainly important for the care of dry, peeling skin. Accordingly, the use of such microemulsions is a particularly preferred embodiment of the invention.

According to a preferred embodiment, the microemulsions comprise further conservation agents that are preferably added in low concentrations below 0.5 wt. % in order to delay a microbiologically controlled deterioration. Salicylic acid, benzoic acid, malic acid, lactic acid, propionic acid, acetic acid, fumaric acid and/or sorbic acid and/or their derivatives and/or salts can serve as examples of conservation agents. Salicylic acid, sorbic acid, their derivatives and/or salts are particularly suitable.

Microemulsions, in which are comprised such active materials that are beneficial to the fiber elasticity, shape retention and break strength of the fabric fibers, in particular aminosiloxanes, cellulose derivatives and/or carboxylic acid esters, are very advantageous in the overall context of the invention, such that the use of such microemulsions also illustrates a particularly preferred embodiment of the invention.

The viscosity of the microemulsions can be measured using standard methods (for example using a Brookfield-Viscosimeter LVT-II with DV II at 22° C., 20 rpm, spindle 3) and lies advantageously in a range from 5 to 5000 mPas.

The viscosity of the microemulsion to be used according to the invention is mainly of interest in regard to the stability of the microemulsion, wherein particularly microemulsions with viscosities in the range of preferably 5 to 300 mPas, advantageously between 20 and 180 mPas and particularly between 25 and 120 mPas are advantageous, measured with the Brookfield-Viscosimeter DV II at 22° C., 20 rpm, spindle 3. Accordingly, the use of these microemulsions is also a particularly preferred embodiment of the invention. Advantageously, such microemulsions can be quite particularly well dispensed into the washing machine.

Advantageously, the just mentioned viscosities confer not only a good stability, but also a good dispersability in water to the inventive microemulsions.

The applicant has now discovered that for good dispensability of an after-treatment agent (e.g. softeners), highly viscous after-treatment agents are detrimental to the dispensing performance. A viscosity of the after-treatment agent should preferably not exceed 300 mPas for good dispensability. This is due to the fact that use is usually made of the “siphon effect” when dispensing rinse aids such as e.g. softeners into the washing machine. The rinse aid that is intended for the washing at the end of the wash is liquid and would therefore run into the machine immediately at the beginning. Therefore it normally comes into a separate compartment with a bent tube, a “siphon”. At the end of the washing cycle, when the rinse aid is required, the machine simply introduces some water into the compartment and the rinse aid then flows by itself through the tube into the washing machine. However, if the rinse aid is too viscous, then the rinse aid cannot completely run out, as the water column flowing out of the compartment (mixture of water flowing in and rinse aid) breaks up.

At viscosities below 300 mPas, however, normal emulsions with droplet sizes greater than 500 nm or in the micrometer range are simply not stable. Such normal emulsions require viscosities of more than 500 mPas at 22° C. in order to be sufficiently stable in the usual temperature range of 10 to 45° C. Moreover, a normal emulsion is too hydrophobic.

The dispensability of normal emulsions with a viscosity of 300 mPas, in comparison with the inventive microemulsions, is in contrast at best adequate, these emulsions being still unstable. The dispensability of normal emulsions that are stable, i.e. exhibiting a viscosity of more than 500 mPas, is on the other hand inadequate to unsatisfactory. Such unfavorable emulsions have to be added by the consumer in a special container that is specially designed for direct use in the tub.

In comparison, the applicant has now discovered that the dispensability of rinse aids from the dispensing draw provided in the washing machine is very good for the inventive microemulsions that moreover are stable and easily dispersible in water.

Similarly, in regard to the dispensability and the stability of the microemulsion, its density is of interest, wherein a microemulsion with a density in the range 0.900 to 1.050 g/cm³, preferably between 0.950 and 1.030 g/cm³ and particularly between 0.980 and 1.015 g/cm³ at 22° C. can be considered as very advantageous. Accordingly, the use of such microemulsions is a particularly preferred embodiment of the invention.

With regard to the skin-functional aspect of the invention, the addition of suitable silicones in the emulsion is also of importance. A microemulsion, which comprises a silicone, advantageously an essentially linear di-(C₁₋₅) alkylpolysiloxane or (C₁₋₅) alkylarylpolysiloxane, very advantageously a polydimethylsiloxane, wherein the silicone is preferably comprised in the microemulsion in amounts of up to 10 wt. %, particularly in amounts of 0.1 to 5 wt. %, is regarded as advantageous in this background, and consequently the use of such advantageous microemulsions is a particularly preferred embodiment of the invention.

According to a preferred embodiment, the microemulsions further comprise proteins or protein derivatives, such as e.g. soja protein, wheat proteins, potato proteins, pea proteins, rice proteins, silk proteins, keratin, actin, elastin, albumins, globulins, (milk-) casein or their derivatives, and/or protein hydrolyzates, such as e.g. collagen. These are absorbed well on the fibers during the fabric treatment, thereby protecting the fibers, and can be released there from onto the skin and thereby are absorbed onto the skin protecting the skin, as well as improving the physical properties of the skin and its moisture retention capability. According to a preferred embodiment, proteins, protein derivatives and/or protein hydrolyzates are comprised in a total amount of preferably 0.1 to 25 wt. %, advantageously 1 to 20 wt. %, further advantageously 1.5 to 15 wt. %, more advantageously 2 to 10 wt. %, in particular in a total amount of up to 5 wt. % based on the total microemulsion.

According to a preferred embodiment, the microemulsions further comprise tea extracts, particularly tea extract from green tea, in a total amount of preferably 0.01 to 10 wt. %, advantageously 0.05 to 5 wt. %, particularly 0.1 to 3 wt. %, based on the total microemulsion.

In a further embodiment, the microemulsions to be used according to the invention comprise one or a plurality of any active materials that are disclosed in EP 0 789 070 A1, i.e. active materials from the group of the waxes, the hydrophobic plant extracts, certain hydrocarbons, higher fatty acids and esters, essential oils, lipids, vitamins, sun-protection agents, phospholipids, derivatives of alpha-hydroxy acids and/or mixtures of the mentioned components each in the mentioned amounts and in even more than these, wherein preferably less than 4 wt. % of quatemary ammonium compounds or other relevant fabric softening compounds are comprised. The extensive absence of relevant fabric softening compounds is advantageous in the just mentioned context when a possible reduction of the fiber absorption capacity should be precluded.

A further subject matter of the invention is illustrated by a fabric treatment agent, particularly selected from the group of liquid detergents or after-treatment agents, preferably softeners or rinse aids that include at least the components a) antioxidants b) at least one lipophilic, preferably lipophilic cationic emulsifier, c) at least one hydrophilic, preferably hydrophilic non-ionic emulsifier, as well as d) oils, preferably oils with skin-protecting and/or skin-caring and/or skin-healing properties, wherein the agent is present as the microemulsion with a droplet size d₅₀ below 500 nm, wherein it preferably comprises less than 5 wt. % of cationic surfactants.

The agent, particularly a after-treatment agent, advantageously possesses a viscosity in the range 5 to 300 mPas. Agents with viscosities in the range of preferably 20 to 180 mPas, particularly from 25 to 120 mPas, illustrate a preferred embodiment of the invention. These low viscosities are particularly advantageous in regard to the after-treatment agent (e.g. softeners) as has already been depicted in connection with the “siphon effect”.

The agents, particularly liquid detergents, can, however, also advantageously exhibit higher viscosities. Advantageously, the viscosity of the microemulsions can be in a range of 5 to preferably 5000 mPas, wherein stable and well water-dispersible microemulsions are present.

With regard to the nature of the oil and the emulsifiers, reference is made to the previous description, which is hereby referenced. In particular, the oils cited by name are preferably added.

Also, in regard to additional ingredients, such as e.g. the ethereal oils, particular reference is made to the previous description in regard to the microemulsions to be used according to the invention.

Such an agent is advantageous on many grounds. It is particularly advantageous that a very good dispensability from the dispensing draw of a washing machine is made possible by the presentation form of the microemulsion and the specific droplet size. In this way a good stability of the emulsion is guaranteed. In addition, the agent is easily dispersible, even in cold water. The high ecological compatibility of the agent is particularly advantageous, which inter alia implies that an upper limit of 5 wt. % cationic surfactant is preferably not exceeded. Commonly, quaternary ammonium compounds are employed as the cationic surfactants. Such ammonium compounds, as all nitrogen-containing compounds, may still represent an environmental pollution factor, even if nowadays they can be better biologically decomposed. Due to its composition, however, the inventive agent allows a good softening performance, thereby enabling a reduction of the cationic surfactant content to below 5 wt. %. In spite of the low cationic surfactant content, the softening performance is still good. Indeed, it is comparable with that of conventional softeners that usually have very high contents of cationic surfactants, for example 15-20 wt. % cationic surfactant. The cationic surfactant can simultaneously serve as the cationic, preferably lipophilic emulsifier or co-emulsifier.

In summary, the inventive agent represents a very skin friendly and ecologically friendly product that has a good fabric softening action and is also capable of serving the skin, in that the comprised oils are at least partially absorbed by the fabrics in the washing tub during a fabric treatment process in a washing machine and on contact of these fabrics with human skin, are at least partially released from the fabric onto the skin and they thereby produce a cosmetic or sensory benefit. Because the agent is present according to the invention in the form of a stable microemulsion, a good dispensability of the agent into the washing machine is assured. This good dispensability of the agent is an advantage that should not be underestimated. The same is true for the good dispersability of the agent in water.

In a preferred embodiment, the agents comprise only natural antioxidants as the antioxidants, in particular selected from terpene-containing antioxidants, vitamin E, vitamin C, vitamin A, and/or selenium and/or their derivatives, vitamin E being mostly preferred. In regard to the antioxidant, the explanations already provided above are particularly valid and reference is hereby made to them.

In a preferred embodiment, the agents comprise an acidic buffer, preferably an organic buffer, particularly citric acid and/or citrate(s). Such agents that comprise an acidic buffer that buffers the microemulsion and the fabric treatment bath preferably in a pH range of 2 to 6.5. particularly 3 to 5.5, also illustrates a preferred embodiment of the invention. Reference is also particularly made to the explanations provided above and are referred to here.

In a preferred embodiment, the agents comprise cationic polymer, advantageously in the form of polymeric quaternary ammonium compounds, particularly selected from copolymers of quaternized vinyl imidazole and vinyl pyrrolidone, copolymers of vinyl caprolactam, vinyl pyrrolidone and quaternized vinyl imidazole and/or quaternized copolymers of vinyl pyrrolidone and dimethylaminoethyl methacrylates. Reference is also particularly made to the explanations provided above and are referred to here.

The term fabric treatment bath is understood here to mean in particular the washing liquid with which the fabric comes into contact and remains during the treatment in an automatic washing machine.

A preferred embodiment is also then when the buffer system comprises acid, preferably selected from formic acid, citric acid, acetic acid, sulfonic acid—advantageously amidosulfonic acid—and/or their derivatives or mixtures thereof.

If the buffer system comprises at least one salt of the acid(s) comprised in the buffer system, preferably sodium citrate, then a likewise preferred embodiment exists.

Also, agents with a buffer system comprising polyacrylates, polymethacrylates and/or copolymers of acrylic acid and maleic acid, preferably with a molecular weight of 2000 to 10 000, represent a preferred embodiment.

An inventive agent, in which a total quantity of cationic surfactant does not exceed 4 wt. %, preferably 3 wt. %, advantageously 2.5 wt. %, particularly 2 wt. % therefore illustrates a preferred embodiment of the invention.

An inventive agent, which comprises fatty acids, preferably in the range of 2 to 4 wt. %, represents a preferred embodiment of the invention. As has been described above, the fatty acids can further stabilize the agent and additionally support the absorption of the oils onto the fabric, such that almost all of the comprised oil can be deposited onto the fabric. Reference is also particularly made to the explanations provided above and are referred to here.

An inventive agent that comprises moisture-retaining factors, such as e.g. glycerin or polyaspartic acid, represents a preferred embodiment of the invention. As has been described above, these substances can support the skin balance and prevent the skin drying out. Reference is also particularly made to the explanations provided above and are referred to here.

Besides the components a) antioxidant, b) lipophilic emulsifier, c) hydrophilic emulsifier as well as d) oils, a very preferred inventive fabric treatment agent accordingly comprises, e) fatty acid(s) as well as f) an acidic buffer that buffers the agent and the fabric treatment bath in a pH range of advantageously 2 to 6.5, preferably 3 to 5.5, as well as optionally g) moisture retaining factors and eventually other components that were listed in the course of this specification, such as e.g. ethereal oils. In regard to these additional components, reference is particularly made to the explanations provided above and are referred to here.

According to a preferred embodiment, the agents further comprise proteins or protein derivatives, such as e.g. soja protein, wheat proteins, potato proteins, pea proteins, rice proteins, silk proteins, keratin, actin, elastin, albumins, globulins, (milk-) casein or their derivatives, and/or protein hydrolyzates, such as e.g. collagen. These are absorbed well on the fibers during the fabric treatment, thereby protecting the fibers, and can be released there from onto the skin and thereby are absorbed onto the skin protecting the skin, as well as improving the physical properties of the skin and its moisture retention capability. According to a preferred embodiment, proteins, protein derivatives and/or protein hydrolyzates are comprised in a total amount of preferably 0.1 to 25 wt. %, advantageously I to 20 wt. %, further advantageously 1.5 to 15 wt. %, more advantageously 2 to 10 wt. %, in particular in a total amount of up to 5 wt. % based on the total agent.

According to a preferred embodiment, the microemulsions further comprise tea extracts, particularly tea extract from green tea, in a total amount of preferably 0.01 to 10 wt. %, advantageously 0.05 to 5 wt. %, particularly 0.1 to 3 wt. %, based on the total microemulsion.

Preferred embodiments of the invention are found in the use of an inventive agent as the liquid detergent as well as in the use as the after-treatment agent, particularly as the softener or rinse aid.

In addition to the previously described components of the fabric treatment agent or the microemulsion, the inventive liquid detergent can comprise all components that are required and/or are customary for a liquid detergent. These components are well known to the person skilled in the art. When necessary he can also find them in relevant reviews e.g. E. Smulders, “Laundry Detergents”, Wiley-VCH, 2nd edition, 2001. Similarly, the inventive after-treatment agent, particularly as the softener or rinse aid, can comprise any agents that are required and/or customary for such an agent.

Liquid detergents advantageously comprise surfactant(s), wherein anionic, non-ionic, cationic and/or amphoteric surfactants can be employed. Mixtures of anionic and non-ionic surfactants are preferred from the technical viewpoint. The total surfactant content of the liquid detergent is preferably below 40 wt. % and particularly preferably below 35 wt. %, based on the total liquid detergent.

As non-ionic surfactants for the liquid detergents are preferably alkoxylated, advantageously ethoxylated, particularly primary alcohols preferably containing 8 to 18 carbon atoms and, on average, 1 to 12 moles of ethylene oxide (EO) per mole of alcohol, in which the alcohol group may be linear or, preferably, methyl-branched in the 2-position or may contain linear and methyl-branched groups in the form of the mixtures typically present in oxoalcohol groups. Particularly preferred are, however, alcohol ethoxylates with linear alcohol groups of natural origin with 12 to 18 carbon atoms, e.g. from coco-, palm-, tallow- or oleyl alcohol, and an average of 2 to 8 EO per mole alcohol. Exemplary preferred ethoxylated alcohols include C₁₂₋₁₄ alcohols with 3 EO, 4EO or 7EO, C₉₋₁₁ alcohol with 7 EO, C₁₃₋₁₅ alcohols with 3 EO, 5 EO, 7 EO or 8 EO, C₁₂₋₁₈ alcohols with 3EO, 5EO or 7EO and mixtures thereof, as well as mixtures of C₁₂₋₁₄ alcohols with 3 EO and C₁₂₋₁₈ alcohols with 7 EO. The cited degrees of ethoxylation constitute statistically average values that can be a whole or a fractional number for a specific product. Preferred alcohol ethoxylates have a narrowed homolog distribution (narrow range ethoxylates, NRE). In addition to these non-ionic surfactants, fatty alcohols with more than 12 EO can also be used. Examples of these are tallow fatty alcohol with 14 EO, 25 EO, 30 EO or 40 EO. Also, non-ionic surfactants that comprise the EO- and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, in which EO- and PO- units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G), can be added, where R means a primary linear or methyl-branched, particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which defines the distribution of monoglycosides and oligoglycosides, is any number between 1.0 and 10, preferably between 1.2 and 1.4.

Another class of preferred non-ionic surfactants which can be used, are alkoxylated, preferably ethoxylated or ethoxylated and propoxylated fatty acid alkyl esters preferably containing I to 4 carbon atoms in the alkyl chain, more particularly the fatty acid methyl esters which are described, for example, in Japanese patent application JP 58/217598 or which are preferably produced by the process described in International Patent application WO-A-90/13533.

Non-ionic surfactants of the amine oxide type, for example N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, particularly no more than half that quantity.

Other suitable surfactants are polyhydroxyfatty acid amides corresponding to the Formula (III), 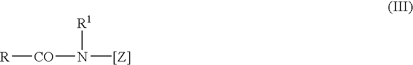
in which RCO stands for an aliphatic acyl group with 6 to 22 carbon atoms, R¹ for hydrogen, an alkyl or hydroxyalkyl group with 1 to 4 carbon atoms and [Z] for a linear or branched polyhydroxyalkyl group with 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to Formula (3), 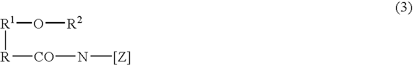
in which R is a linear or branched alkyl or alkenyl group containing 7 to 12 carbon atoms, R¹ is a linear, branched or cyclic alkyl group or an aryl group containing 2 to 8 carbon atoms and R² is a linear, branched or cyclic alkyl group or an aryl group or an oxyalkyl group containing 1 to 8 carbon atoms, C₁₋₄ alkyl or phenyl groups being preferred, and [Z] is a linear polyhydroxyalkyl group, of which the alkyl chain is substituted by at least two hydroxy groups, or alkoxylated, preferably ethoxylated or propoxylated derivatives of that group.

[Z] is preferably obtained by reductive amination of a sugar, for example glucose, fructose, maltose, lactose, galactose, mannose or xylose. The N-alkoxy- or N-aryloxy-substituted compounds may then be converted, for example according to the teaching of the international application WO-A-95/07331, into the required polyhydroxyfatty acid amides by reaction with fatty acid methyl esters in the presence of an alkoxide as catalyst.

The total content of non-ionic surfactants in the liquid detergents is preferably 5-30 wt. %, advantageously 7-20 wt. % and particularly 9-15 wt. %, in each case based on the total weight of the agent.

Anionic surfactants are also suitable ingredients of liquid detergents. Exemplary suitable anionic surfactants are those of the sulfonate and sulfate type. Suitable surfactants of the sulfonate type are, advantageously C₉₋₁₃-alkylbenzene sulfonates, olefin sulfonates, i.e. mixtures of alkene- and hydroxyalkane sulfonates, and disulfonates, as are obtained, for example, from C₁₂-₁₈-monoolefins having a terminal or internal double bond, by sulfonation with gaseous sulfur trioxide and subsequent alkaline or acidic hydrolysis of the sulfonation products. Those alkane sulfonates, obtained from C₁₂₋₁₈ alkanes by sulfochlorination or sulfoxidation, for example, with subsequent hydrolysis or neutralization, are also suitable. The esters of α-sulfofatty acids (ester sulfonates), e.g. the α-sulfonated methyl esters of hydrogenated coco-, palm nut- or tallow acids are likewise suitable.

Further suitable anionic surfactants are sulfated fatty acid esters of glycerine. They include the mono-, di- and triesters and also mixtures of them, such as those obtained by the esterification of a monoglycerin with 1 to 3 moles fatty acid or the transesterification of triglycerides with 0.3 to 2 moles glycerin. Preferred sulfated fatty acid esters of glycerol in this case are the sulfated products of saturated fatty acids with 6 to 22 carbon atoms, for example caproic acid, caprylic acid, capric acid, myristic acid, lauric acid, palmitic acid, stearic acid or behenic acid.

Preferred alk(en)yl sulfates are the alkali and especially sodium salts of the sulfuric acid half-esters derived from the C₁₂-C₁₈ fatty alcohols, for example from coconut butter alcohol, tallow alcohol, lauryl, myristyl, cetyl or stearyl alcohol or from C₁₀-C₂₀ oxo alcohols and those half-esters of secondary alcohols of these chain lengths. Additionally preferred are alk(en)yl sulfates of the said chain lengths, which contain a synthetic, straight-chained alkyl group produced on a petro-chemical basis, which show similar degradation behaviour to the suitable compounds based on fat chemical raw materials. The C₁₂-C₁₆-alkyl sulfates and C₁₂-C₁₅-alkyl sulfates and C₁₄-C₁₅ alkyl sulfates are preferred on the grounds of laundry performance. The 2,3-alkyl sulfates, which are manufactured according to the U.S. Pat. Nos. 3,234,258 or 5,075,041, and which can be obtained from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, for example 2-methyl-branched C₉₋₁₁ alcohols with an average of 3.5 mole ethylene oxide (EO) or C₁₂₋₁₈ fatty alcohols with 1 to 4 EO. Due to their high foaming performance, they are preferably only used in relatively small amounts, for example in amounts of 1 to 5% by weight.

Other suitable anionic surfactants are the salts of alkylsulfosuccinic acid, which are also referred to as sulfosuccinates or esters of sulfosuccinic acid and the monoesters and/or di-esters of sulfosuccinic acid with alcohols, preferably fatty alcohols and especially ethoxylated fatty alcohols. Preferred sulfosuccinates contain C₈₋₁₈ fatty alcohol groups or mixtures of them. Especially preferred sulfosuccinates contain a fatty alcohol residue derived from the ethoxylated fatty alcohols that are under consideration as non-ionic surfactants (see description below). Once again the especially preferred sulfosuccinates are those, whose fatty alcohol residues are derived from ethoxylated fatty alcohols with narrow range distribution. It is also possible to use alk(en)ylsuccinic acid with preferably 8 to 18 carbon atoms in the alk(en)yl chain, or salts thereof.

Suitable anionic surfactants can also be soaps. Saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

Anionic surfactants, including soaps may be in the form of their sodium, potassium or ammonium salts or as soluble salts of organic bases, such as mono-, di- or triethanolamine. Preferably, anionic surfactants are in the form of their sodium or potassium salts, especially sodium.

The total content of anionic surfactants in the liquid detergents is preferably 2-30 wt. %, advantageously 4-25 wt. % and particularly 5-22 wt. %, in each case based on the total weight of the agent. It is particularly preferred that the amount of fatty acid soap is at least 2 wt. % and particularly preferably at least 4 wt. % and particularly preferably at least 6 wt. %.

Additional ingredients can be comprised in addition to the cited ingredients to improve the technical application properties and/or esthetic properties of the agent. In the context of the present invention, preferred agents can additionally comprise one or a plurality of materials from the group of builders, bleaches, bleach activators, enzymes, electrolytes, non-aqueous solvents, pH adjustors, fragrances, perfume carriers, fluorescent agents, dyes, hydrotropes, foam inhibitors, silicone oils, anti-redeposition agents, optical brighteners, graying inhibitors, laddering retardants, anti-crease agents, color transfer inhibitors, antimicrobials, germicides, fungicides, antioxidants, corrosion inhibitors, antistats, ironing aids, water-repellents and impregnation agents, swelling and non-skid agents and UV-absorbers.

Silicates, aluminum silicates (particularly zeolites), carbonates, salts of organic di- and polycarboxylic acids as well as mixtures of these materials can be particularly cited as builders that are comprised in the liquid detergents.

Suitable crystalline, layered sodium silicates correspond to the general formula NaMSiₓO₂ₓ₊₁.H₂O, wherein M is sodium or hydrogen, x is a number from 1.9 to 4 and y is a number from 0 to 20, preferred values for x being 2, 3 or 4. These types of crystalline layered silicates are described, for example, in the European Patent application EP-A-0 164 514. Preferred crystalline layered silicates of the given formula are those in which M stands for sodium and x assumes the values 2 or 3. Both β- and δ-sodium disilicate Na₂Si₂O₅ yH₂O are particularly preferred, wherein β-sodium disilicate can be obtained for example from the process described in the international Patent application WO-A-91/08171.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over-drying. In the context of this invention, the term “amorphous” also means “X-ray amorphous”. In other words, the silicates do not produce any of the sharp X-ray reflections typical of crystalline substances, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. This type of X-ray amorphous silicates, which similarly possess a delayed dissolution in comparison with the customary water glasses, are described, for example in the German Patent application DE-A44 00 024. Compacted/densified amorphous silicates, compounded amorphous silicates and over dried X-ray-amorphous silicates are particularly preferred.

Of the suitable fine crystalline, synthetic zeolites containing bound water, zeolite A and/or P are preferred. A particularly preferred zeolite P is zeolite MAP® (a commercial product of Crosfield). However, the zeolite X as well as mixtures of A, X and/or P are also suitable. Commercially available and preferred in the context of the present invention is, for example, also a co-crystallizate of zeolite X and zeolite A (ca. 80 wt. % zeolite X), which is marketed under the name of VEGOBOND AX® by SASOL and which can be described by the Formula
nNa₂O.(1−n)K₂O.Al₂O₃.(2−2.5)SiO₂(3.5−5.5)H₂O
n=0.90−1.0

The zeolite can be employed as the spray-dried powder or also as the non-dried, still moist from its manufacture, stabilized suspension. For the case where the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have a mean particle size of less than 10 μm volume distribution, as measured by the Coulter Counter Method) and comprise preferably 18 to 22% by weight and more preferably 20 to 22% by weight of bound water.

Naturally, the generally known phosphates can also be added as builders, in so far that their use should not be avoided on ecological grounds. The sodium salts of the orthophosphates, the pyrophosphates and especially the tripolyphosphates are particularly suitable.

Among the compounds, which serve as bleach agents and liberate H₂O₂ in water, sodium perborate tetrahydrate and sodium perborate monohydrate are of particular importance. Examples of further bleaching agents that may be employed are sodium percarbonate, peroxypyrophosphates, citrate perhydrates and H₂O₂-liberating peracidic salts or peracids, such as perbenzoates, peroxyphthalates, diperoxyazelaic acid, phthaloimino peracid or diperoxydodecanedioic acid.

The detergents can comprise bleach activators in order to achieve an improved bleaching action for washing temperatures of 60° C. and below. Bleach activators, which can be used are compounds which, under perhydrolysis conditions, yield aliphatic peroxycarboxylic acids having preferably 1 to 10 carbon atoms, in particular 2 to 4 carbon atoms, and/or optionally substituted perbenzoic acid. Substances, which carry O-acyl and/or N-acyl groups of said number of carbon atoms and/or optionally substituted benzoyl groups, are suitable. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In addition to, or instead of the conventional bleach activators, so-called bleach catalysts may also be incorporated into the liquid detergents. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands and cobalt-, iron-, copper- and ruthenium-amine complexes may also be used as bleach catalysts.

Suitable enzymes are, in particular, those from the classes of hydrolases, such as proteases, esterases, lipases or lipolytic enzymes, amylases, cellulases or other glycosyl hydrolases and mixtures thereof. In the wash, all these hydrolases contribute to removing stains such as protein, fat or starchy stains and against graying. Moreover, cellulases and other glycosyl hydrolases can contribute to increased softness of the textile and to color retention by removing pilling and micro fibrils. Oxireductases can also be added for bleaching or for reducing color transfer. Enzymatic active materials obtained from bacterial sources or fungi such as bacillus subtilis, bacillus licheniformis, streptomyceus griseus und humicola insolens are particularly well suited. Proteases of the subtilisin type and particularly proteases that are obtained from bacillus lentus, are preferably used. Here, mixtures of enzymes are of particular interest, for example proteases and amylases or proteases and lipases or lipolytic enzymes or proteases and cellulases or cellulases and lipase or lipolytic enzymes or proteases, amylases and lipases or lipolytic enzymes or proteases, lipases or lipolytic enzymes and cellulases, in particular, however proteases and/or lipase-containing mixtures or mixtures with lipolytic enzymes Examples of such lipolytic enzymes are the known cutinases. Peroxidases or oxidases have also proved to be suitable in certain cases. The suitable amylases particularly include α-amylases, iso-amylases, pullulanases and pectinases. Cellobiohydrolases, endoglucanases and β-glucosidases or mixtures thereof, which are also known as cellobiases are preferred cellulases. As the different cellulase types differ in their CMCase- and avicelase activities, the required activities can be adjusted by means of controlled mixtures of the cellulases.

The enzymes can be adsorbed on carriers in order to protect them against premature decomposition. The content of the enzymes, enzyme mixtures or enzyme granules may be, for example, about 0.1 to 5% by weight and is preferably 0.12 to about 2.5% by weight.

A large number of the most varied salts can be employed as the electrolytes from the group of the inorganic salts. Preferred cations are the alkali and alkali earth metals, preferred anions are the halides and sulfates. The addition of NaCl or MgCl₂ to the agents is preferred from the industrial manufacturing point of view. The content of electrolytes in the agents normally ranges from 0.5 to 5 wt. %.

Non-aqueous solvents that can be added to the liquid detergents originate for example from the group of mono- or polyvalent alcohols, alkanolamines or glycol ethers, in so far that they are miscible with water in the defined concentrations. Preferably, the solvents are selected from ethanol, n- or i-propanol, butanols, glycol, propanediol or butanediol, glycerin, diglycol, propyldiglycol or butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, butoxy propoxy propanol (BPP), dipropylene glycol methyl-, or -ethyl ether, diisopropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents. Non-aqueous solvents can be added to the liquid detergents in amounts preferably between 0.5 and 15 wt. %, preferably, however below 12 wt. % and particularly below 9 wt. %.

Soaps, paraffins or silicone oils, optionally deposited on carrier materials, are examples of the foam inhibitors that can be added to the liquid detergents. Suitable anti-redeposition agents, also referred to as soil repellents are, for example, non-ionic cellulose ethers such as methyl cellulose and methyl hydroxypropyl cellulose with a content of methoxy groups of 15 to 30 wt. % and hydroxypropyl groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene glycol terephthalates or anionically and/or non-ionically modified derivatives thereof. From these, the sulfonated derivatives of the phthalic acid polymers and the terephthalic acid polymers are particularly preferred.

Optical brighteners can be added to the liquid detergents in order to eliminate graying and yellowing of the treated fabric surfaces. These materials absorb onto the fiber and effect a brightening and pseudo bleach effect in that the invisible ultraviolet radiation is converted into visible radiation, wherein the ultraviolet light absorbed from sunlight is irradiated away as weak blue fluorescence and results in pure white for the yellow shade of the grayed or yellowed washing. Suitable compounds originate for example from the substance classes of 4,4′-diamino-2,2′-stilbenedisulfonic acids (flavonic acids), 4,4′-distyrylbiphenylene, methylumbelliferone, cumarine, dihydroquinolinones, 1,3-diarylpyrazolines, naphthoic acid imide, benzoxazole-, benzisoxazole- and benzimidazole-systems as well as heterocyclic substituted pyrene derivatives. Optical brighteners are usually added in amounts between 0.03 and 0.3 wt. %, based on the finished agent.

Graying inhibitors have the function of maintaining the dirt that was removed from the fibers suspended in the washing liquor, thereby preventing the dirt from resettling. Water-soluble colloids of mostly organic nature are suitable for this, for example glue, gelatins, salts of ether sulfonic acids of starches or celluloses, or salts of acidic sulfuric acid esters of celluloses or starches. Water-soluble, acid group-containing polyamides are also suitable for this purpose. Moreover, soluble starch preparations and others can be used as the abovementioned starch products, e.g. degraded starches, aldehyde starches etc. Polyvinyl pyrrolidone can also be used. Preference, however, is given to the use of cellulose ethers such as carboxymethyl cellulose (Na salt), methyl cellulose, hydroxyalkyl cellulose and mixed ethers such as methyl hydroxyethyl cellulose, methyl hydroxypropyl cellulose, methyl carboxymethyl cellulose and mixtures thereof, which can be added, for example in amounts of 0.1 to 5 wt. %, based on the agent.

As fabric surfaces, particularly of rayon, spun rayon, cotton and their mixtures can wrinkle of their own accord because the individual fibers are sensitive to flection, bending, pressing and squeezing at right angles to the fiber direction, the agents can comprise synthetic wrinkle-protection agents. They include for example synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

The liquid detergents can comprise antimicrobials for an increased combat of microorganisms. Depending on the antimicrobial spectrum and the action mechanism, antimicrobial agents are classified as bacteriostatic agents and bactericides, fungistatic agents and fungicides, etc. Important representatives of these groups are, for example, benzalkonium chlorides, alkylaryl sulfonates, halophenols and phenol mercuric acetate, wherein for the inventive agents in particular, these compounds can be totally dispensed with.

The agents can comprise additional antioxidants in order to prevent undesirable changes to the liquid detergents and/or the treated fabric surfaces caused by oxygen and other oxidative processes. This class of compounds includes, for example, substituted phenols, hydroquinones, pyrocatechols and aromatic amines as well as organic sulfides, polysulfides, dithiocarbamates, phosphites and phosphonates.

An increased wear comfort can result from the additional use of antistats that can be additionally included in the agents. Antistats increase the surface conductivity and thereby allow an improved discharge of built-up charges. Generally, external antistats are substances with at least one hydrophilic molecule ligand and provide a more or less hygroscopic film on the surfaces. These mainly interface active antistats can be subdivided into nitrogen-containing (amines, amides, quaternary ammonium compounds), phosphorus-containing (phosphoric acid esters) and sulfur-containing (alkyl sulfonates, alkyl sulfates) antistats. External antistats are described, for example, in the patent applications FR 1,156,513, GB 873 214 and GB 839 407. Lauryl (or stearyl) dimethyl benzyl ammonium chlorides disclosed here are suitable antistats for fabric surfaces or as additives to detergents, resulting in an additional finishing effect.

Silicone derivatives, for example, can be added to the inventive agents to improve the water-absorption capacity, the wettability of the treated fabric surfaces and to facilitate ironing of the treated fabrics. They additionally improve the final rinse behavior of the agents by means of their foam-inhibiting properties. Exemplary preferred silicone derivatives are polydialkylsiloxanes or alkylarylsiloxanes, in which the alkyl groups possess one to five carbon atoms and are totally or partially fluorinated. Preferred silicones are polydimethylsiloxanes that can be optionally derivatized and then be aminofunctional or quaternized or possess Si—OH, Si—H and/or SiCl bonds. The viscosities of the preferred silicones at 25° C. are in the range between 100 and 100 000 mPas, wherein the silicones can be added in amounts between 0.2 and 5 wt. % based on the total agent.

Finally, the liquid detergents can also comprise UV absorbers, which are absorbed on the treated textiles and improve the light stability of the fibers. Compounds, which possess these desired properties, are for example, the efficient radiationless deactivating compounds and derivatives of benzophenone having substituents in position(s) 2-and/or 4. Also suitable are substituted benzotriazoles, acrylates that are phenyl-substituted in position 3 (cinnamic acid derivatives), optionally with cyano groups in position 2, salicylates, organic Ni complexes, as well as natural substances such as umbelliferone and the endogenous urocanic acid.

Substances can be added to complex heavy metals in order to prevent heavy metal catalyzed decomposition of certain detergent ingredients. Suitable heavy metal sequestrants are, for example, the alkali salts of ethylene diamine tetraacetic acid (EDTA) or of nitrilotriacetic acid (NTA) as well as alkali metal salts of anionic polyelectrolytes such as polyacrylates, polymaleates and polysulfonates.

A preferred class of sequestrants are the phosphonates that are comprised in preferred detergents in amounts of 0.01 to 2.5 wt. %, preferably 0.02 to 2 wt. % and particularly 0.03 to 1.5 wt. %. These preferred compounds particularly include organophosphonates such as for example 1-hydroxyethane-1,1-diphosphonic acid (HEDP), aminotri(methylenephosphonic acid) (ATMP), diethylene triamine penta(methylenephosphonic acid) (DTPMP or DETPMP) as well as 2-phosphonobutane-1,2,4-tricarboxylic acid (PBS-AM), that are mainly added in the form of their ammonium or alkali metal salts.

In addition to these ingredients, an agent in conformity with the invention, preferably detergents, can comprise dispersed particles whose diameter along the greatest dimension ranges from 0.01 to 10 000 μm.

In the scope of this invention, particles can be microcapsules and also granulates, compounds and fragrance bubbles, microcapsules being preferred.

The term “microcapsule” is understood to mean aggregates that comprise at least one solid or liquid core that is encapsulated by at least one continuous casing, particularly a casing of polymer(s). They usually are finely dispersed liquid or solid phases that are encapsulated by film-forming polymers, whereby during production, the polymers, after emulsification and coacervation or interfacial polymerization, precipitate out on the material being encapsulated. The microscopically small capsules can be dried like powders. Besides single-core microcapsules, multi-core aggregates—also called microspheres—are also known and comprise two or more cores arranged in the continuous encapsulating material. Moreover, single- or multi-core microcapsules can be encapsulated by an additional second, third etc. casing. Single-core microcapsules with a continuous casing are preferred. The casing can consist of natural, semi-synthetic or synthetic materials. Exemplary natural casing materials are gum arabicum, agar agar, maltodextrins, alginic acid or its salts, e.g. sodium or calcium alginate, fats and fatty acids, cetyl alcohol, collagen, chitosan, lecithin, gelatin, albumin, shellac, polysaccharides, such as starch or dextran, sucrose and waxes. Semi-synthetic casing materials include inter alia chemically modified celluloses, particularly cellulose esters and ethers, e.g. cellulose acetate, ethyl cellulose, hydroxypropyl cellulose, hydroxypropyl methyl cellulose and carboxymethyl cellulose as well as starch derivatives, particularly starch ethers and esters. Exemplary synthetic casing materials are polymers such as polyacrylates, polyamides, polyvinyl alcohol or polyvinyl pyrrolidone.

Sensitive, chemically or physically incompatible and volatile components (=active substances) of the aqueous liquid detergent are advantageously encapsulated inside the microcapsules and are storage and transport-stable. Optical brighteners, surfactants, sequestrants, bleaching agents, bleach activators, dyes, fragrances, antioxidants, builders, enzymes, enzyme stabilizers, antimicrobials, graying inhibitors, pH adjustors, electrolytes, foam inhibitors and UV absorbers are examples of materials that can be found in the microcapsules. In addition to the abovementioned constituents that are not ingredients of the inventive aqueous liquid detergents, the microcapsules can comprise for example cationic surfactants, vitamins, proteins, preservatives, boosters or pearlizers. The contents of the microcapsules can be solids or liquids in the form of solutions or emulsions or suspensions.

According to a preferred embodiment, the agents comprise conservation agents that are preferably added in low concentrations, advantageously below 0.5 wt. % in order to delay a microbiologically controlled deterioration. Salicylic acid, benzoic acid, malic acid, lactic acid, propionic acid, acetic acid, fumaric acid and/or sorbic acid and/or their derivatives and/or salts serve as examples of conservation agents. Salicylic acid, sorbic acid, their derivatives and/or salts are particularly suitable.

In the scope of the manufacturing process, the microcapsules can have any shape, however, they are preferably approximately spherical. Their diameter along the greatest spatial dimension can be between 0.01 μm (not visually recognizable as capsules) and 10 000 μm depending on the encapsulated components and the application. Visible microcapsules with a diameter in the range 100 μm to 7000 μm, particularly 400 μm to 5000 μm, are preferred The microcapsules can be obtained by means of processes known from the prior art, wherein coacervation and interfacial polymerization have the most importance. All the commercially available, surfactant-stable microcapsules can be used as the microcapsules, for example the commercial products (the casing/encapsulating material is given in each case in brackets) Hallcrest Microcapsules (gelatin, gum Arabicum), Coletica Thalaspheres (maritime collagen), Lipotec Millicapseln (alginic acid, agar-agar), Induchem Unispheres (lactose, microcrystalline cellulose, hydroxypropyl methyl cellulose); Unicerin C30 (lactose, microcrystalline cellulose, hydroxypropyl methyl cellulose), Kobo Glycospheres (modified starch, fatty acid ester, phospholipids), Softspheres (modified agar agar) and Kuhs Probiol Nanospheres (phospholipids).

Alternatively, particles can also be used that do not have a core-casing structure, but rather in which the active substance is dispersed in a matrix of a matrix-forming material. Such particles are also referred to as “speckles”.

A preferred matrix-forming material is alginate. Alginate-based speckles are manufactured by dropping an aqueous alginate solution that also comprises the encapsulatable active substances or substances, followed by hardening in a precipitation bath containing Ca²⁺ ions or Al³⁺ ions.

It can be advantageous to subsequently wash the alginate-based speckles with water and then wash them again in an aqueous solution with a sequestrant so as to wash out free Ca²⁺ ions or free Al³⁺ ions that could cause undesirable effects with the ingredients of the liquid detergent, e.g. the fatty acid soaps. Finally, the alginate-based speckles are washed again with water to remove excess sequestrant.

Alternatively, other matrix-forming materials can be used instead of alginate. Examples of matrix-forming materials include polyethylene glycol, polyvinyl pyrrolidone, polymethacrylate, polylysin, polyoxamer, polyvinyl alcohol, polyacrylic acid, polyethylene oxide, polyethoxyoxazoline, albumin, gelatin, acacia, chitosan, cellulose, dextran, ficoll®, starch, hydroxyethyl cellulose, hydroxypropyl cellulose, hydroxypropyl methylcellulose, hyaluronic acid, carboxymethyl cellulose, carboxymethyl cellulose, deacetylated chitosan, dextran sulfate and derivatives of these materials. These materials form matrices, for example by gelation, polyanion-polycation interactions or polyelectrolyte-metal ion interactions and, exactly like the manufacture of particles, the use of these matrix-forming materials is well known from the prior art.

The particles can be stably dispersed into the aqueous liquid detergent. Stable means that the agents are stable at room temperature and at 40° C. for a period of at least 4 weeks and preferably for at least 6 weeks without the agents creaming or sedimenting.

The release of the active substances from the microcapsules or speckles normally occurs during the use of the agent by destruction of the casing or matrix from mechanical, thermal, chemical or enzymatic action. In a preferred embodiment of the invention, the liquid detergents comprise the same or different particles in amounts of 0.01 to 10 wt. %, particularly 0.2 to 8 wt. % and most preferably 0.5 to 5 wt. %.

### EXAMPLES

The following inventive composition (Fabric treatment agent AA), consisting of

| | | |
|---|---|---|
| water | 55.75 | parts by wt. |
| citric acid * 1H₂O | 3.50 | parts by wt. |
| Na citrate * 2H₂O | 1.75 | parts by wt. |
| Dehyquart ® AU 56 | 4.00 | parts by wt. |
| Luviquat ® Excellence | 0.20 | parts by wt. |
| Eumulgin ® B3 | 0.25 | parts by wt. |
| almond oil | 30.00 | parts by wt. |
| rosemary oil | 0.40 | parts by wt. |
| ethanol 96% | 4.00 | parts by wt. |
| formic acid | 0.05 | parts by wt. |
| Tocomix ® L 70 (antioxidant) | 0.10 | parts by wt. |

was prepared.

The composition was prepared with vigorous stirring at ca. 40° C. in the form of a dispersion and subsequently passed three consecutive times through a high pressure homogenizer (Niro Soavi Co. GEA, Type NS 3006) at 500 bar and a temperature of 50±5° C. On cooling, a stable microemulsion was obtained that dispersed well in water and could be easily dispensed from the dispensing chamber of a washing machine. The droplet size d₅₀ was ca. 120 nm.

Luviquat® Excellence corresponds to 3-methylvinyl imidazoline chloride vinyl pyrrolidone copolymer ex BASF AG; Dehyquart® AU 56 corresponds to dihydrogenated tallow hydroxyethylammonium methosulfate ex Cognis GmbH & Co.KG; Eumulgin® B3 corresponds to cetylstearyl alcohol +30-EO (ethylene oxide adduct) ex Cognis GmbH & Co. KG, Tocomix® L 70 corresponds to D-mixed tocopherol in Sunflower oil ex Jan Dekker Netherlands B.V.

The pH of the composition was 3.5. The viscosity of the composition was 48 mPas (Brookfield; spindle 3; 20 rpm; 23° C.).

The stability of the composition after 1 hour was good, after one day was also good and after one week still good. The dispensability from the dispensing chamber (softener compartment) of an automatic washing machine was also good, likewise the dispersability in water (even at 20° C.).

Examination and detection of the transfer of components of fabrics treated with the fabric treatment agent AA to the skin:

Three kg of fabrics made of fine rib cotton were washed with water in an automatic washing machine with 50 ml of the fabric treatment agent AA, wherein the application of the fabric treatment agent AA occurred in the rinse cycle. The fabrics treated in this way were dried on the line in fresh air. The treated fabric was then used for the examination and detection of the transfer of components of fabrics treated with the fabric treatment agent AA to the skin: This fabric is designated in the following as “treated fabric”.

For comparison, three kg of fabrics made of fine rib cotton were washed with water, no fabric treatment agent being added, i.e. the fabric was only exposed to water. The fabrics treated in this way were dried on the line in fresh air. This fabric is designated in the following as “untreated fabric”.

For the transfer detection, test fields were defined on the forearms of five test subjects. The right forearm of the test subjects served as the test surfaces for untreated fabric, the left forearm as the test surface for treated fabric. The test fields each took up a surface of 10×15 cm. The fields received the field designations p (proximal), m (medial) and d (distal).

The aim was the detection of a measurable fat deposition after rubbing or 24 hour wearing of the treated fabrics by analysing for triglyceride (C18:2).

Each of these fields were then individually rubbed 5 times with a gauze cloth that had been moistened with 1 ml isopropanol (orientation value for the untreated situation). Then the degreased surfaces were individually rubbed again 5 times with a gauze cloth and 1 ml isopropanol (starting value for the fat-free situation).

The treatment 1 (rubbing test) was then carried out. In addition the surface d was rubbed 20 times with a 10×10 cm fabric cloth. The fabric cloth for the left arm each corresponded to “treated fabric”, the fabric cloth for the right arm each corresponded to “untreated fabric”. Finally, all surfaces were individually rubbed 5 times with gauze cloths that had been dipped into 1 ml isopropanol.

For treatment 2 (24 hour wear test), a 5×10 cm fabric cloth (left arm “treated fabric”, right arm “untreated fabric”) was applied in such a manner that the test field p was completely covered. After 24 hours the cloths were removed and the surfaces p and m were rubbed 5 times with a gauze cloth and 1 ml isopropanol.

Work Up of the Samples

The gauze cloths were stirred overnight with 5 ml isopropanol and internal standard. The organic phases were separated and transesterified with methanol-BF₃ and analyzed by means of GC-MS-FID coupling.

The contents of C18:2 fatty acid methyl ester (in μg) can be seen from the following tables:

| | | Subject 1 | |
|---|---|---|---|
| | | left FA | right FA |
| | | fabric treated | fabric untreated |
| | | μg/extract | μg/extract |
| orientation value for the untreated | p | 5 | 10 |
| situation | m | 4 | 5 |
| | d | 3 | 5 |
| starting value for the fat-free situation | p | 5 | 5 |
| | m | 5 | 4 |
| | d | 4 | 4 |
| extraction after treatment 1: | d | 8 | 4 |
| rubbing test | | | |
| extraction of the blank value for | m | 5 | 5 |
| treatment 1 | | | |
| extraction after treatment 2: 24 hour | p | 17 | 4 |
| wear | | | |
| extraction of the blank value for | m | 4 | 5 |
| treatment 2 after 24 hours | | | |

| | | Subject 2 | |
|---|---|---|---|
| | | left FA | right FA |
| | | fabric treated | fabric untreated |
| | | μg/extract | μg/extract |
| orientation value for the untreated | p | 5 | 3 |
| situation | m | 3 | 3 |
| | d | 5 | 4 |
| starting value for the fat-free situation | p | 5 | 4 |
| | m | 3 | 4 |
| | d | 4 | 5 |
| extraction after treatment 1: rubbing | d | 8 | 4 |
| test | | | |
| extraction of the blank value for | m | 3 | 3 |
| treatment 1 | | | |
| extraction after treatment 2: 24 hour | p | 5 | 2 |
| wear | | | |
| extraction of the blank value for | m | 3 | 2 |
| treatment 2 after 24 hours | | | |

| | | Subject 3 | |
|---|---|---|---|
| | | left FA | right FA |
| | | fabric treated | fabric untreated |
| | | μg/extract | μg/extract |
| orientation value for the untreated | p | 8 | 5 |
| situation | m | 6 | 5 |
| | d | 4 | 4 |
| starting value for the fat-free situation | p | 6 | 5 |
| | m | 5 | 4 |
| | d | 4 | 3 |
| extraction after treatment 1: rubbing | d | 7 | 3 |
| test | | | |
| extraction of the blank value for | m | 6 | 5 |
| treatment 1 | | | |
| extraction after treatment 2: 24 hour | p | 10 | 4 |
| wear | | | |
| extraction of the blank value for | m | 5 | 6 |
| treatment 2 after 24 hours | | | |

| | | Subject 4 | |
|---|---|---|---|
| | | left FA | right FA |
| | | fabric treated | fabric untreated |
| | | μg/extract | μg/extract |
| orientation value for the untreated | p | 9 | 9 |
| situation | m | 9 | 7 |
| | d | 9 | 10 |
| starting value for the fat-free situation | p | 6 | 8 |
| | m | 5 | 5 |
| | d | 4 | 5 |
| extraction after treatment 1: rubbing | d | 6 | 3 |
| test | | | |
| extraction of the blank value for | m | 3 | 3 |
| treatment 1 | | | |
| extraction after treatment 2: 24 hour | p | 11 | 3 |
| wear | | | |
| extraction of the blank value for | m | 6 | 5 |
| treatment 2 after 24 hours | | | |

| | | Subject 5 | |
|---|---|---|---|
| | | left FA | right FA |
| | | fabric treated | fabric untreated |
| | | μg/extract | μg/extract |
| orientation value for the untreated | p | 6 | 6 |
| situation | m | 6 | 6 |
| | d | 5 | 6 |
| starting value for the fat-free situation | p | 5 | 4 |
| | m | 5 | 4 |
| | d | 4 | 5 |
| extraction after treatment 1: rubbing | d | 8 | 3 |
| test | | | |
| extraction of the blank value for | m | 5 | 3 |
| treatment 1 | | | |
| extraction after treatment 2: 24 hour | p | 17 | 4 |
| wear | | | |
| extraction of the blank value for | m | 5 | 4 |
| treatment 2 after 24 hours | | | |

As can be seen from the tables, significantly more triglyceride could be detected on the skin for all subjects when the subjects' skin was treated with “treated fabrics”.

The following picture resulted for the rubbing test:

Subject 1: the content of the resulting C18:2 fatty acid methyl ester, on rubbing with “treated fabric”, was about 100% above the value observed for rubbing with “untreated fabric”.

Subject 2: the content of the resulting C18:2 fatty acid methyl ester, on rubbing with “treated fabric”, was about 100% above the value observed for rubbing with “untreated fabric”.

Subject 3: the content of the resulting C18:2 fatty acid methyl ester, on rubbing with “treated fabric”, was about 133% above the value observed for rubbing with “untreated fabric”.

Subject 4: the content of the resulting C18:2 fatty acid methyl ester, on rubbing with “treated fabric”, was about 100% above the value observed for rubbing with “untreated fabric”.

Subject 5: the content of the resulting C18:2 fatty acid methyl ester, on rubbing with “treated fabric”, was about 166% above the value observed for rubbing with “untreated fabric”.

The “wear test” showed an even clearer picture:

Subject 1: the content of the resulting C18:2 fatty acid methyl ester, on wearing the “treated fabric”, was about 325% above the value observed for that wearing the “untreated fabric”.

Subject 2: the content of the resulting C18:2 fatty acid methyl ester, on wearing the “treated fabric”, was about 150% above the value observed for that wearing the “untreated fabric”.

Subject 3: the content of the resulting C18:2 fatty acid methyl ester, on wearing the “treated fabric”, was about 150% above the value observed for that wearing the “untreated fabric”.

Subject 4: the content of the resulting C18:2 fatty acid methyl ester, on wearing the “treated fabric”, was about 266% above the value observed for that wearing the “untreated fabric”.

Subject 5: the content of the resulting C18:2 fatty acid methyl ester, on wearing the “treated fabric”, was about 325% above the value observed for that wearing the “untreated fabric”.

It is therefore established that on contact with skin, the treated fabric transfers components of the fabric treatment agent AA to the skin. This transfer benefits the skin and serves as a skin-care. It has also been established that a transfer of components of the fabric treatment agent AA to the fabric occurs during fabric treatment in the automatic washing machine.

1-57. (canceled)

58. A method comprising:
(a) providing a microemulsion comprising an oil and an emulsifier system, wherein the emulsifier system comprises a hydrophilic emulsifier and a lipophilic emulsifier; and
(b) contacting a fabric with the microemulsion in an automatic washing machine.

59. The method according to claim 58, wherein contacting the fabric with the microemulsion is carried out during a rinse cycle.

60. The method according to claim 58, wherein the microemulsion has a droplet size d₅₀ of less than 500 nm.

61. The method according to claim 58, wherein the microemulsion further comprises a cationic polymer.

62. The method according to claim 61, wherein the cationic polymer is present in an amount less than 10 wt. %, based on the microemulsion.

63. The method according to claim 62, wherein the cationic polymer comprises a polymeric quaternary ammonium compound.

64. The method according to claim 58, wherein the microemulsion further comprises a sequestering agent.

65. The method according to claim 64, wherein the sequestering agent comprises a component selected from the group consisting of citrates, citric acid, gluconates, gluconic acid, phosphates, phosphonates, carboxylates, ethylenediaminetetraacetic acid and salts thereof, nitrilotriacetic acid and salts thereof, diethylenetriaminepentaacetic acid and salts thereof, propylenediaminetetraacetic acid and salts thereof, alaninediacetic acid and salts thereof, methylglycinediacetic acid and salts thereof, iminodisuccinic acid and salts thereof, a trisodium salt of ethylenediamine-N,N′-disuccinic acid, and mixtures thereof.

66. The method according to claim 58, wherein the emulsifier system comprises a cationic emulsifier.

67. The method according to claim 58, wherein the lipophilic emulsifier comprises a cationic emulsifier.

68. The method according to claim 67, wherein the cationic emulsifier comprises a quaternary ammonium compound.

69. The method according to claim 58, wherein the emulsifier system comprises a non-ionic emulsifier.

70. The method according to claim 58, wherein the hydrophilic emulsifier comprises a non-ionic emulsifier.

71. The method according to claim 58, wherein the oil is present in an amount of 0.5 to 50 wt. %, based on the microemulsion.

72. The method according to claim 58, wherein the microemulsion further comprises a thickener, and wherein the thickener is present in an amount of 0.05 to 3 wt. %, based on the emulsion.

73. The method according to claim 58, wherein the microemulsion has a pH less than or equal to 6.5 at 20° C., as measured via a 1% aqueous solution of the microemulsion.

74. The method according to claim 58, wherein the microemulsion further comprises an acidic buffer.

75. The method according to claim 58, wherein the microemulsion has a viscosity of 5 to 300 mPas, measured with a Brookfield-Viskosimeter DV II at 22° C., 20 rpm, spindel 3.

76. The method according to claim 58, wherein the microemulsion has a density of 0.900 to 1.050 g/cm at 22° C.

77. A microemulsion comprising: an oil, an antioxidant, and an emulsifier system; wherein the emulsifier system comprises a hydrophilic emulsifier and a lipophilic emulsifier; and wherein the microemulsion has a droplet size d₅₀ less than 500 nm.

78. The microemulsion according to claim 77, wherein the lipophilic emulsifier comprises a cationic emulsifier.

79. The microemulsion according to claim 77, wherein the hydrophilic emulsifier comprises a non-ionic emulsifier.

80. The microemulsion according to claim 77, further comprising a cationic polymer.

81. The microemulsion according to claim 77, further comprising an acidic buffer.
